(19) United States
(12) Patent Application Publication
(10) Pub. No.: US 2025/0044611 A1
(43) Pub. Date: Feb. 6, 2025

(54) AIR FLOATING VIDEO INFORMATION DISPLAY SYSTEM

(71) Applicant: Maxell, Ltd., Kyoto (JP)

(72) Inventors: Hiroaki TAKAHASHI, Kyoto (JP); Koji HIRATA, Kyoto (JP); Koji FUJITA, Kyoto (JP); Toshinori SUGIYAMA, Kyoto (JP)

(21) Appl. No.: 18/719,296

(22) PCT Filed: Nov. 22, 2022
(86) PCT No.: PCT/JP2022/043228

§ 371 Date: Jun. 13, 2024

(30) Foreign Application Priority Data
Dec. 14, 2021 (JP) 2021-202546
Feb. 22, 2022 (JP) 2022-025713

(51) Int. Cl. G02B 30/56

(52) U.S. Cl. CPC G02B 30/56

(57) ABSTRACT

A video is suitably displayed outside a space. The present invention contributes to the following sustainable development goals: “3. Good health and well-being”; “9. Industry, innovation and infrastructure”; and “11. Sustainable cities and communities”. This air floating video display system includes: a display panel for displaying images; a light source apparatus for supplying light to the display panel; and a retroreflector that reflects image light from the display panel and that causes the air floating video to be displayed as a real image in air by using the reflected light.

### TECHNICAL FIELD

The present invention relates to an air floating video information display system and an optical system used therefor.

### BACKGROUND ART

As an air floating video information display system, a video display apparatus that directly displays a video toward the outside and a display method in which the video is displayed as a space screen have already been known. Further, a detection system that reduces erroneous detection for an operation on an operation surface of a displayed space image has also been disclosed in, for example, Patent Document 1.

### RELATED ART DOCUMENTS

### Patent Documents

Patent Document 1: Japanese Patent Laid-Open No. 2019-128722

### SUMMARY OF THE INVENTION

### Problems to be Solved by the Invention

As an air floating video information display system, a video display apparatus that directly displays a video toward the outside and a display method in which the video is displayed as a space screen have already been known. However, in the above-described conventional air floating video information display system, means for preventing a malfunction occurring when external light is incident on a retroreflector that generates an air floating video and a technique for optimizing a design including a light source of a video display apparatus as a video source of the air floating video have not been considered.

An object of the present invention is to provide, in an air floating information display system or an air floating video display apparatus, a technique capable of displaying an air floating video having a high visibility (apparent resolution and contrast) and subjected to a reduced influence of external light and capable of displaying a favorable video.

### Means for Solving the Problems

In order to solve the above-described problems, configurations described in the claims, for example, are adopted. Although the present application includes a plurality of means for solving the above-described problems, an air floating video information display apparatus as an example thereof is given below. An air floating video information display system as an example of the present application includes a display panel that displays a video, a light source apparatus that supplies light to the display panel, and a retroreflector that reflects an air floating video as a real image in air by the reflected light.

### Effects of the Invention

According to the present invention, air floating video information can be favorably displayed without the image quality of an air floating video decreasing even if external light is incident. Problems, configurations, and effects other than the foregoing will be made apparent from the following description of an embodiment.

### DRAWINGS

FIG. 1 is a diagram showing a configuration of a retroreflector and a position where an air floating image is generated according to one embodiment of the present invention;

FIG. 2 is an explanatory diagram for explaining a mechanism of generating a ghost image due to an extraordinary ray generated by retroreflection according to one embodiment of the present invention;

FIG. 3 is an explanatory diagram for explaining a mechanism of generating extraordinary rays generated by a retroreflector used in another air floating video information system;

FIG. 4 is an explanatory diagram for explaining a mechanism for eliminating extraordinary rays generated when external light is incident on the retroreflector according to one embodiment of the present invention;

FIG. 5 is a characteristic diagram showing the optimum usage condition of the retroreflector in the air floating video information display system according to one embodiment of the present invention;

FIG. 6A is a view showing an example of a principal part configuration and a retroreflection portion configuration of the air floating video information display system according to one embodiment of the present invention;

FIG. 6B is a view showing an example of a principal part configuration and a retroreflection portion configuration of the air floating video information display system according to one embodiment of the present invention;

FIG. 6C is a view showing an example of a principal part configuration and a retroreflection portion configuration of the air floating video information display system according to one embodiment of the present invention;

FIG. 6D is a view showing an example of a principal part configuration and a retroreflection portion configuration of the air floating video information display system according to one embodiment of the present invention;

FIG. 6E is a view showing an example of a principal part configuration and a retroreflection portion configuration of the air floating video information display system according to one embodiment of the present invention;

FIG. 7 is a view showing a second example of a principal part configuration and a retroreflection portion configuration of the air floating video information display system according to one embodiment of the present invention;

FIG. 8 is a view showing a third example of a principal part configuration and a retroreflection portion configuration of the air floating video information display system according to one embodiment of the present invention;

FIG. 9A is a view showing a fourth example of a principal part configuration and a retroreflection portion configuration of the air floating video information display system according to one embodiment of the present invention;

FIG. 9B is a view showing a fifth example of a principal part configuration and a retroreflection portion configuration of the air floating video information display system according to one embodiment of the present invention;

FIG. 10 is an explanatory diagram for explaining an operating principle of an optical member refracting video light and used in the air floating video information display system of the present invention;

FIG. 11 is an explanatory diagram for explaining an arrangement of an optical member and a video source that prevents a viewing person from directly viewing a display video of the video source used in the air floating video information display system of the present invention;

FIG. 12 is a cross-sectional view showing an arrangement of members for blocking extraordinary rays generated in a retroreflection portion according to one embodiment of the present invention;

FIG. 13 is a diagram showing a principal part configuration of a first example of an air floating video information display system according to one embodiment of the present invention;

FIG. 14 is a diagram showing an external appearance and a principal part configuration of a second embodiment of an air floating video information display system according to one embodiment of the present invention;

FIG. 15 is a diagram showing an external appearance and a principal part configuration of a third embodiment of an air floating video information display system according to one embodiment of the present invention;

FIG. 16 is an explanatory diagram for explaining sensing means provided in the air floating video information display system according to an embodiment of the present invention;

FIG. 17 is a view showing another example of a specific configuration of a light source apparatus of another system;

FIG. 18A is a view showing another example of a specific configuration of a light source apparatus of another system;

FIG. 18B is a view extracting a part of another example of a specific configuration of a light source apparatus of another system;

FIG. 18C is a view extracting a part of another example of a specific configuration of a light source apparatus of another system;

FIG. 18D is a view extracting a part of another example of a specific configuration of a light source apparatus of another system;

FIG. 19A is a structural diagram showing another example of a specific configuration of a light source apparatus of another type;

FIG. 19B is a diagram showing another example of a specific configuration of a light source apparatus of another type;

FIG. 20 is an enlarged view showing a surface shape of a light guiding body diffusing part of another example of the specific configuration of the light source apparatus;

FIG. 21 is a cross-sectional view showing an example of a specific configuration of the light source apparatus;

FIG. 22 is a cross-sectional view showing an example of a specific configuration of the light source apparatus;

FIG. 23 is a perspective view, a top view, and a cross-sectional view showing an example of a specific configuration of a light source apparatus;

FIG. 24 is a perspective view and a top view showing an example of a specific configuration of a light source apparatus;

FIG. 25 is an explanatory diagram for explaining light source diffusion characteristics of a video display apparatus;

FIG. 26 is an explanatory diagram for explaining light source diffusion characteristics of a video display apparatus;

FIG. 27 is an explanatory diagram for explaining diffusion characteristics of a video display apparatus;

FIG. 28 is an explanatory diagram for explaining diffusion characteristics of a video display apparatus;

FIG. 29 is a diagram showing a coordinate system for measuring visual characteristics of a liquid crystal panel;

FIG. 30 is a diagram showing luminance angle characteristics (longitudinal direction) of a general liquid crystal panel;

FIG. 31 is a diagram showing luminance angle characteristics (short direction) of a general liquid crystal panel;

FIG. 32 is a diagram showing angular characteristics (longitudinal direction) of contrast of a general liquid crystal panel; and

FIG. 33 is a diagram showing the angle characteristics (short direction) of the contrast of the general liquid crystal panel;

### DETAILED DESCRIPTION OF PREFERRED EMBODIMENTS

Hereinafter, an embodiment of the present invention will be described in detail with reference to the drawings. Note that the present invention is not limited to contents of the embodiment (hereinafter also referred to as “present disclosure”) described below. The present invention also covers the spirit of the invention, the scope of the technical idea described in the claims, or equivalents thereof. Further, configurations of the embodiment (examples) described below are only illustrative, and various changes and modifications can be made by those skilled in the art within the scope of the technical idea disclosed in the present specification.

Further, in the drawings for describing the present invention, components having the same or similar functions are respectively denoted by the same reference signs, and different names are respectively appropriately used therefor. On the other hand, repetitive description of the functions and the like may be omitted. Note that in the following description of an embodiment, a video floating in a space is expressed as a term “air floating video”. Instead, this term may be expressed as “aerial image”, “space image”, “aerial floating video”, “air floating optical image of a display image”, “aerial floating optical image of a display image”, or the like. The term “air floating video” mainly used in the description of the embodiment is used as a typical example of these terms.

The present disclosure relates to an information display system capable of transmitting a video based on video light from a video light emission source having a large area through a transparent member that partitions a space such as a show window glass and displaying the video as an air floating video inside or outside a store (space). Further, the present disclosure relates to a large-scale digital signage system configured using a plurality of such information display systems.

According to the following embodiment, high-resolution video information can be displayed above a glass surface of a show window or a light-transmittable plate material while floating in air, for example. At this time, only regularly reflected light can be efficiently reflected with respect to a retroreflector by making a divergence angle of video light to be emitted small, i.e., an acute angle and equalizing the video light to have a specific polarized wave. This results in a high light utilization efficiency, makes it possible to suppress a ghost image, which has been a problem in a conventional retroreflection system, to be generated in addition to a main air floating image, and makes it possible to obtain a clear air floating video.

Further, an apparatus including the light source in the present disclosure makes it possible to provide an air floating video information display system capable of significantly reducing power consumption and being new and excellent in availability. Further, a technique of the present disclosure makes it possible to provide a floating video information display system vehicle capable of displaying a so-called unidirectional air floating video that is visually recognizable outside a vehicle through a shield glass including a windshield, a rear window, and a side window.

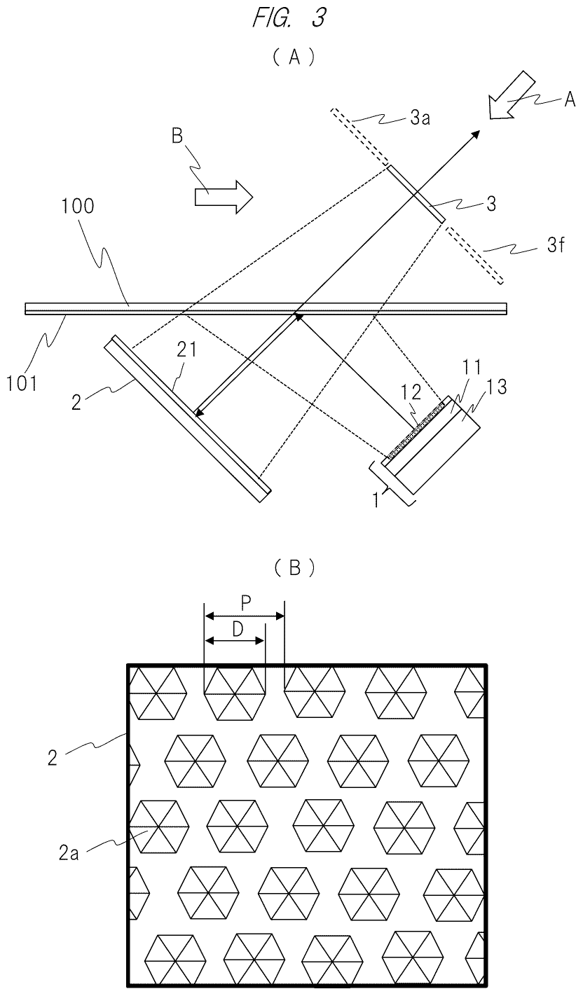

On the other hand, in a conventional air floating video information display system, an organic EL panel or a liquid crystal display panel (a liquid crystal panel or a display panel) is combined with a retroreflector as a high-resolution color display video source. In a first retroreflector 2 used in the air floating video display apparatus according to the conventional technique, video light is diffused at a wide angle. Accordingly, besides reflected light to be regularly reflected by the retroreflector that is a first example composed of a polyhedron illustrated in FIG. 3 since a shape used for a retroreflector 2a as illustrated in FIG. 3 is a polyhedron, six ghost images including ghost images respectively indicated by signs 3a and 3f are generated by video light to be obliquely incident, which deteriorating the image quality of an air floating video. Further, the same air floating video as the ghost image is also viewed by a person other than a viewing person, thereby also presenting a large problem from a viewpoint of security.

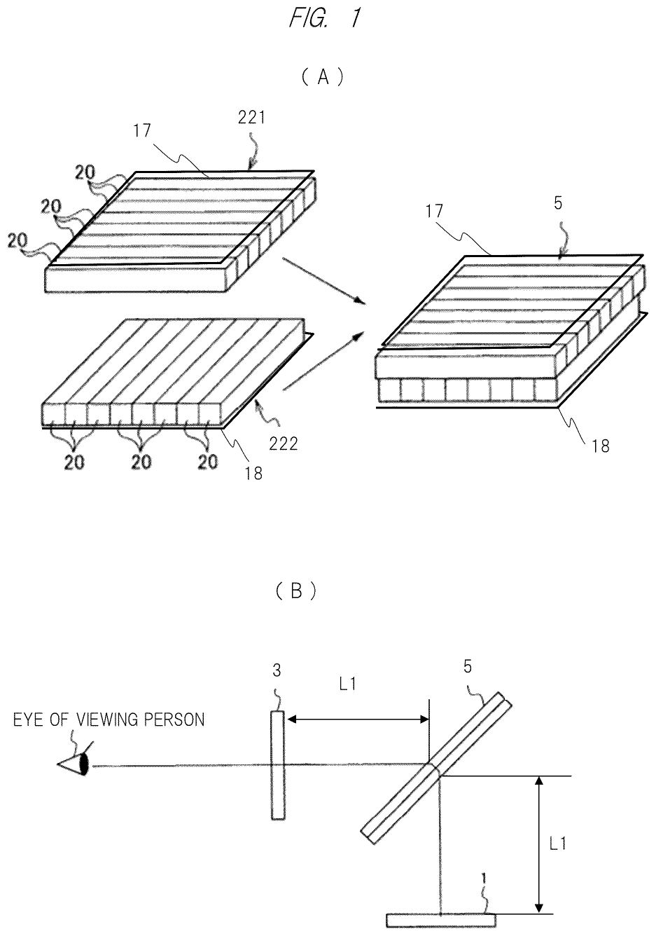

Further, in a second retroreflector 5 used in an air floating video display apparatus, a first light control panel 221 and a second light control panel 222 are formed by vertically arranging optical members 20 with a constant pitch each having a large number of and strip-shaped planar light reflection portions side by side on respective surfaces on one side of transparent flat plates 18 and 17 each having a predetermined thickness as illustrated in FIG. 1(A). Here, the light reflection portions of the optical members 20 respectively constituting the first light control panel 221 and the second light control panel 222 are arranged to intersect each other (in an orthogonal state in this example) in a plain view.

Then, a function of the second retroreflector used in the air floating video display apparatus and specific examples of the air floating video display apparatus will be described. As illustrated in FIG. 1(B), the second retroreflector 5 is generally arranged to be inclined at an angle of 40 to 50 degrees with respect to the video display apparatus 1. At this time, video light is emitted from the second retroreflector 5 to an air floating video 3 at the same angle as an angle at which it is incident on the second retroreflector 5. At this time, the air floating video is formed at a symmetric position spaced by the same distance as a distance L1 between the video display apparatus 1 and the second retroreflector 5.

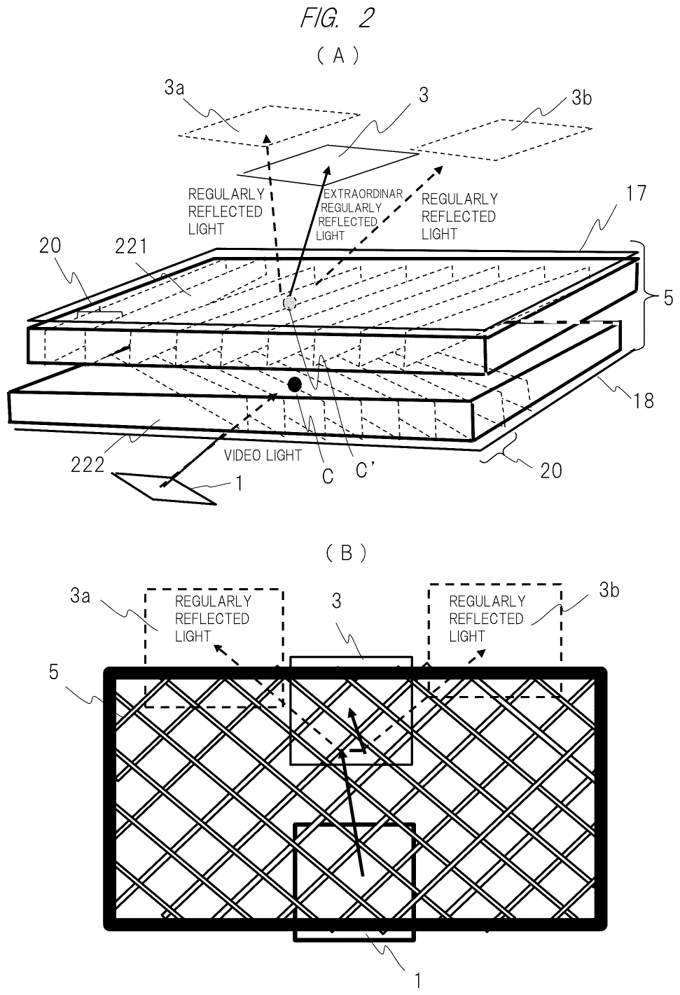

Hereinafter, a mechanism for forming an air floating video will be described in detail with reference to FIGS. 1 and 2. Video light emitted from the video display apparatus 1 provided on one side of the second retroreflector 5 is reflected by a planar light reflection portion C (a reflection surface of a light reflector 20) in the second light control member 222, and is then reflected by a planar light reflection portion C′ (a reflection surface of the light reflector 20) in the first light control member 221 to form the air floating image 3 (a real image) at a position outside the second retroreflector 5 (a space on the other side). That is, the second retroreflector 5 is used, thereby establishing an air floating video information apparatus. In the space, an image of the video display apparatus 1 can be displayed as an air floating image.

In the second retroreflector 5 described above, the two reflection surfaces exist, as described above. Accordingly, two ghost images 3a and 3b corresponding to the number of reflection surfaces are generated besides to the air floating image 3 as illustrated in FIGS. 2A and 2B.

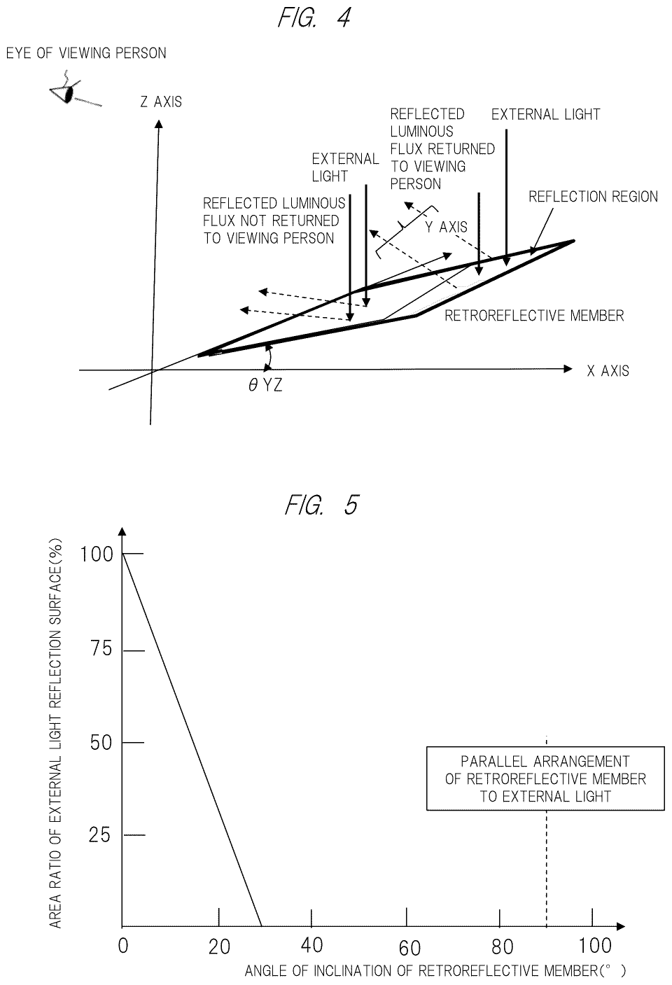

Furthermore, if the intensity of external light is high, a distance (300 μm or less) between the reflection surfaces is shortened when the external light is incident from an upper surface of the second retroreflector 5. Accordingly, it has been found out that there are such harmful effects that a light interference occurs, iridescently reflected light is observed, and the viewing person recognizes the existence of the retroreflector. An area in which interference light to be generated by a pitch of the reflection surfaces in the retroreflector 5 by the incidence of the external light is experimentally found by a measurement environment illustrated in FIG. 4 using an angle of incidence of the external light as a parameter such that the interference light does not return to the viewing person. Obtained results are illustrated in FIG. 5. It has been found out that when the pitch of the reflection surfaces is 300 μm and the height of each of the reflection surfaces is 300 μm, the interference light does not return toward the viewing person if the retroreflector is inclined by an angle of inclination OYz of 35 degrees or more.

On the other hand, it has been found out that at a ratio (H/P) of a pitch P of the light reflector 20 and a height H of the reflection surface thereof, described above, about 60% of the reflection surface forms an air floating image by retroreflection and remaining 40% is extraordinarily reflected light for generating a ghost image. Hereinafter, it is essential to shorten the pitch of the reflection surfaces to improve the resolution of the air floating video. In addition, it is necessary to make the height of the reflection surface higher than that at present to suppress the generation of the ghost image. However, as the ratio (H/P) of the pitch P and the height H of the reflection surfaces, a range from 0.8 to 1.2 may be selected with respect to 1.0 at present due to a manufacturing contrast of the second retroreflector 5.

As a result of the above-described study, the inventors have studied a retroreflection optical system that implements an increase in the image quality of an air floating video obtained in an air floating video information display system using a second retroreflector in which an amount of generation of ghost images is, in principle, small, leading to the invention of the present application. Description will be made in detail below with reference to the drawings.

<First Configuration Example of Retroreflection Optical System Forming Air floating video Information Display System>

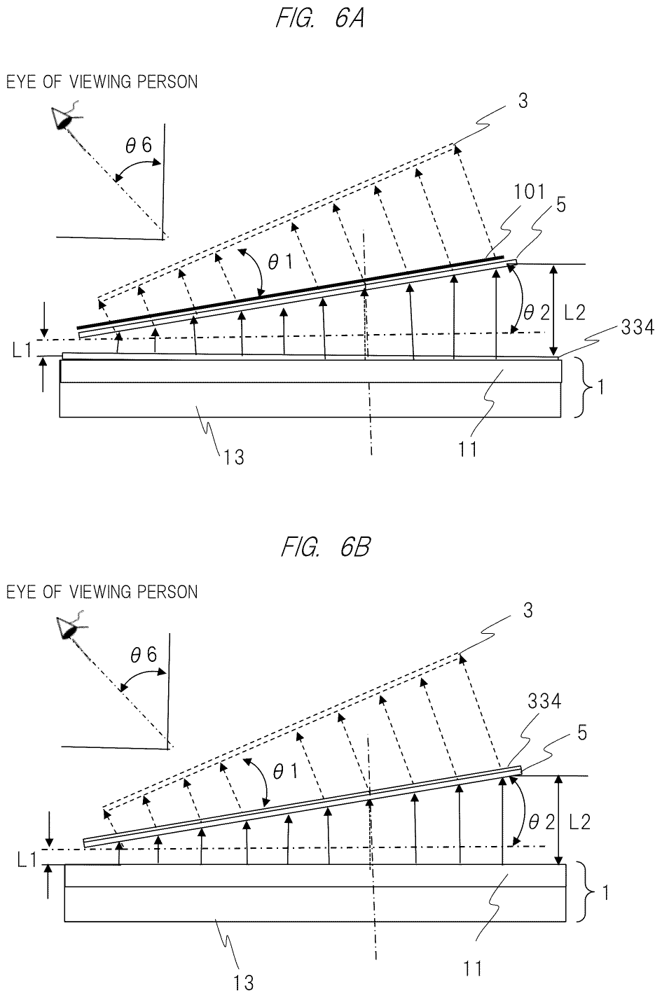

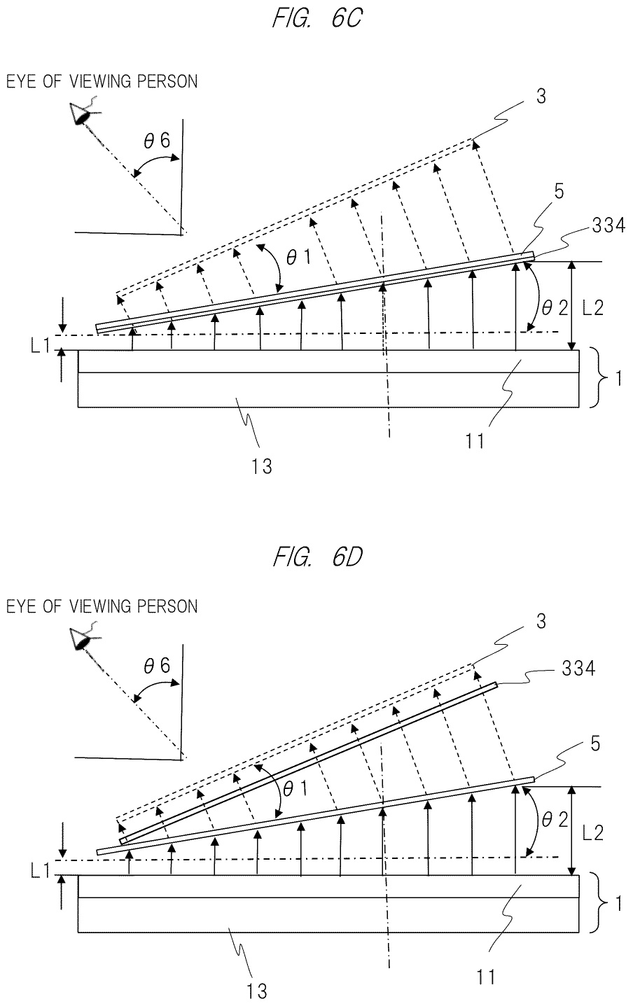

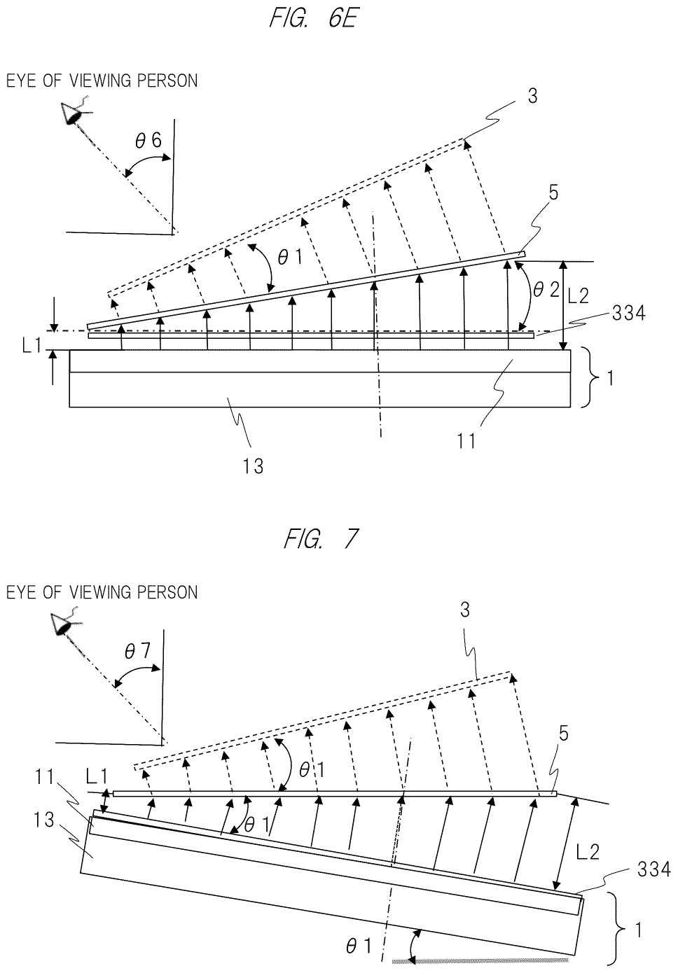

FIGS. 6A to 6C are diagrams each illustrating an example of a form of the retroreflection optical system used to implement the air floating video information display system according to the present disclosure. Further, FIGS. 6A to 6C are diagrams each illustrating an entire configuration of the air floating video information display system in the present embodiment. Referring to FIGS. 6A to 6C with the air floating video information display system (hereinafter also referred to as “present system”) according to the present disclosure, for example, an air floating video is looked down at an angle θ6 when the air floating video information display system is arranged on a desk for a viewing person of the air floating video. At this time, it has been found out that such an arrangement that an angle (an image forming position) of the air floating image is substantially equal to a sum (θ2+θ1) of an angle θ2 formed between a display surface of the video display apparatus 1 and the retroreflector 5 and an angle θ1 formed between the retroreflector 5 and the air floating image 3, that is, an angle formed between a liquid crystal display panel 11 and the air floating video 3 is θ1+θ2 is an arrangement optimal to view the air floating video. Further, FIG. 6A illustrates an example in which a video light control sheet 334 is arranged on a front surface of the liquid crystal display panel 11. The video light control sheet 334 illustrated in FIGS. 6A to 6C may be arranged between the liquid crystal display panel 11 and the retroreflector 5, or may be arranged on the opposite side to the liquid crystal display panel with respect to the retroreflector 5. That is, in order to erase a ghost image to be generated at this time to obtain a high-quality air floating video 3, the video light control sheet 334 is provided on the emission side of the liquid crystal display panel 11 so that a diffusion property in an unnecessary direction can be controlled. Note that the video light control sheet 334 illustrated in FIGS. 6A to 6C may be expressed as a diffusion property control sheet.

As described above, the air floating video is formed at a position symmetric to the video display apparatus 1 with respect to the second retroreflector 5, so that the angles θ1 and θ2 formed at their respective arrangements are equal to each other. Accordingly, if the angle θ6 at which the viewing person looks down the air floating video display system is determined, the video display apparatus 1 and the second retroreflector 5 may be arranged as the angle θ2=θ6/2 in the retroreflection optical system. Furthermore, a predetermined distance L1 is required to increase the cooling efficiency of the video display apparatus 1 between the video display apparatus 1 and the second retroreflector 5. Furthermore, a distance L2 relative to L1 needs to be determined to structurally obtain the above-described angle θ2.

The configuration of the air floating video information display system according to the present disclosure will be more specifically described. As illustrated in FIG. 6A, there are provided the video display apparatus 1 that diffuses video light with a specific polarized wave at a narrow angle and the second retroreflector 5. The video display apparatus 1 includes the liquid crystal display panel (hereinafter merely referred to as the liquid crystal panel) 11 and a light source apparatus 13 that generates light with a specific polarized wave having a narrow-angle diffusion property.

The video light with a specific polarized wave from the video display apparatus 1 is selectively transmitted by providing a surface, which contacts the outside of an apparatus (not illustrated), of the second retroreflector 5 with an absorption-type light polarization sheet 101 having an antireflection film provided on its front surface to prevent light reflected by a front surface of the second retroreflector 5 from affecting an air floating video obtained by absorbing another polarized wave included in external light.

Here, the absorption-type light polarization sheet 101 that selectively transmits the video light with a specific polarized wave has a property of transmitting the video light with a specific polarized wave. Accordingly, the video light with a specific polarized wave is transmitted by the absorption-type light polarization sheet 101. The air floating video 3 is formed at a position symmetric with respect to the retroreflector 5 by the transmitted video light.

Note that light forming the aerial floating video 3 is an aggregation of light rays converging on an optical image of the aerial floating video 3 from the retroreflector 5, and the light rays travel straight even after passing through the optical image of the aerial floating video 3. Accordingly, the aerial floating video 3 is an image having a high directionality unlike diffused video light formed on a screen by a general projector or the like.

Therefore, in the configuration illustrated in FIG. 6A, the aerial floating video 3 is visually recognized as a bright video when visually recognized by a user in a direction illustrated in the drawing. However, the aerial floating video 3 cannot be visually recognized at all as a video when visually recognized by another person in an up-down direction and a front-rear direction of a plane of paper. This property is very preferable when used for a system that displays a video requiring a high security and a video having a high secret level that is desired to be kept secret from a person who faces the user.

Note that light polarization axes of video light after reflection may be unequal depending on a performance of the retroreflector 5. In this case, a part of the video light, the light polarization axes of which are unequal is absorbed by the above-described absorption-type light polarization sheet 101. Accordingly, unnecessary reflected light is not generated in the retroreflective optical system, thereby making it possible to prevent or suppress a reduction in the image quality of the air floating image.

Further, in the air floating video display apparatus using the retroreflective optical system according to the present disclosure, even when the viewing person looks into the air floating video, a display screen of the video display apparatus 1 is light-shielded by a reflection surface of the retroreflector 5. Accordingly, a display image of the video display apparatus 1 is more difficult to view than that when the video display apparatus 1 and the retroreflector oppose each other.

As illustrated in FIGS. 6A to 6C, light from the light source apparatus 13 having a narrow divergence angle described below is incident on the liquid crystal display panel 11 to generate a video luminous flux having a narrow divergence angle and make the video luminous flux incident on the retroreflector 5, thereby obtaining the air floating image 3. The air floating video 3 is formed at a position symmetric to the video display apparatus 1 with the retroreflector 5 used as a plane of symmetry. In order to erase ghost images to be respectively generated on both sides of the air floating video 3 (a regular image) to be originally formed to obtain a high-quality air floating video 3 at this time, the video light control sheet 334 is provided on the emission side of the liquid crystal display panel 11 so that a diffusion property in an unnecessary direction may be controlled.

A view/light path control film (VCF) manufactured by Shin-Etsu Polymer Co., Ltd., for example, is suitable as the above-described video light control sheet 334, and its structure is a sandwich structure obtained by alternately arranging transparent silicone and black silicone and arranging synthetic resin on a light incidence/emission surface. When the above-described video light control sheet 334 is provided on the emission side of the liquid crystal display panel 11, ghost images to be generated on both sides of the air floating video 3 due to unnecessary light can be erased. For a specific structure of the video light control sheet 334, when a light shielding layer is provided on a vertical surface of the video light control sheet 334, unnecessary light can be prevented from being generated, as illustrated in FIGS. 12(A) and 12(B). Furthermore, when antireflection films are respectively provided on video light incidence and emission surfaces of the video light control sheet 334, unnecessary light is prevented from being generated, thereby making it possible to obtain a good property.

Further, a place where the above-described video light control sheet 334 is arranged may be the front surface of the retroreflector 5, i.e., a surface on the side on which the air floating image 3 is formed as illustrated in FIG. 6B. As a result, when the video light control sheet 334 is provided on the front surface of the retroreflector 5, ghost images to be respectively generated on both side of the air floating video 3 due to unnecessary light can be erased.

In addition, when the above-described video light control sheet 334 is arranged on the front surface of the retroreflector 5 as illustrated in FIG. 6B, reflection of external light on the retroreflector 5 can be reduced. Accordingly, the retroreflector 5 can be prevented from standing out as whitish due to reflection of external light inside the retroreflector 5. Further, when the above-described video light control sheet 334 is arranged on the front surface of the retroreflector 5, a background of the air floating image 3 is close to black. That is, the luminance of the background of the air floating image 3 decreases, thereby producing an effect of improving an apparent contrast of the air floating image 3.

Furthermore, a place where the above-described video light control sheet 334 is arranged may be a back surface of the retroreflector 5, i.e., a surface on the opposite side to the side on which the air floating image 3 is formed as illustrated in FIG. 6C. As a result, ghost images to be respectively generated on both side of the air floating video 3 due to unnecessary light irradiated toward the retroreflector 5 from the video display apparatus 1 can be erased.

Further, when the video light control sheet 334 is arranged on the upper side (front surface) or the lower side (back surface) of the retroreflector 5, as illustrated in FIGS. 6B and 6C, unlike when the video light control sheet 334 is arranged on the front surface of the video display apparatus 1 as illustrated in FIG. 6A, moire due to a pitch of pixels on the liquid crystal display panel 11 and an interference of the video light control sheet 334 does not occur. That is, striped shades due to the pitch of pixels and the interference of the video light control sheet 334 does not occur.

Therefore, in cases illustrated in FIGS. 6B and 6C, there is also an effect of eliminating the necessity of performing a fine adjustment during assembly by making an array or columns or rows of pixels on the liquid crystal display panel 11 have an angle with respect to columns formed by arranging transparent silicone and black silicone in the video light control sheet 334 in order not to generate the above-described moire.

Furthermore, here, an arrangement of the above-described video light control sheet 334 is not limited to arrangement positions respectively illustrated in FIGS. 6A, 6B, and 6C. As a specific example, FIG. 6D illustrates an example in which the video light control sheet 334 is arranged between the retroreflector 5 and a position where the air floating image 3 is formed. FIG. 6E illustrates an example in which the video light control sheet 334 is arranged between the retroreflector 5 and the video display apparatus 1.

FIG. 6D illustrates the example in which the video light control sheet 334 is arranged between the retroreflector 5 and the position where the air floating image 3 is formed.

Specifically, the video light control sheet 334 is arranged in a space between the retroreflector 5 and the air floating image 3, that is, spaces respectively exist between the video light control sheet 334 and the retroreflector 5 and between the video light control sheet 334 and the air floating video 3. Further, in FIG. 6D, the video light control sheet 334 is arranged perpendicularly to video light (indicated by a dotted line arrow) from the retroreflector 5. This configuration makes it possible to erase ghost images to be respectively generated on both side of the air floating video 3 due to unnecessary light, and further to reduce reflection of external light on the retroreflector 5. Furthermore, the retroreflector 5 stands out as whitish due to reflection of external: light inside the retroreflector 5. Accordingly, the retroreflector 5 can be prevented from standing out as whitish by reducing the reflection of the externa light on the retroreflector 5. Further, in the arrangement illustrated in FIG. 6D, a background of the air floating video 3 is the video light control sheet 334. As a result, a background color of the air floating video 3 is close to black. That is, the luminance of the background of the air floating video 3 decreases. Accordingly, there is an effect of improving an apparent contrast of the air floating image 3.

The space exists between the video light control sheet 334 and the retroreflector 5. Accordingly, even when respective pitches of pixels on the video light control sheet 334 and the retroreflector 5 are close values, e.g., both the pitches are values in the vicinity of 100 μm, moire due to an interference between the video light control sheet 334 and the retroreflector 5 does not occur in the formed air floating image 3.

Then, FIG. 6E illustrates the example in which the video light control sheet 334 is arranged between the retroreflector 5 and the video display apparatus 1. Specifically, the video light control sheet 334 is arranged in a space between the retroreflector 5 and the video display apparatus 1, that is, spaces respectively exist between the retroreflector 5 and the video light control sheet 334 and between the video light control sheet 334 and the video display apparatus 1. Further, in FIG. 6E, the video light control sheet 334 is arranged perpendicularly to video light (indicated by a solid line arrow) from the video display apparatus 1. This configuration makes it possible to erase ghost images to be respectively generated on both side of the air floating video 3 because unnecessary light emitted toward the retroreflector 5 from the video display apparatus 1 is reduced by the video light control sheet 334. Further, the video light control sheet 334 exists in a background of the retroreflector 5. Accordingly, a viewing person cannot recognize that the video light control sheet 334 exists.

Furthermore, in the case illustrated in FIG. 6E, the space exists between the video light control sheet 334 and the retroreflector 5 or between the video light control sheet 334 and the video display apparatus 1. Accordingly, even when respective pitches of pixels on the video light control sheet 334, the retroreflector 5, and the video display apparatus 1 are close values, e.g., all the three pitches are values in the vicinity of 100 μm, moire due to an interference does not occur in the formed air floating image 3.

Although FIGS. 6D and 6E respectively illustrate the example in which the video light control sheet 334 is arranged in the space between the retroreflector 5 and the position where the air floating image 3 is formed and the example in which the video light control sheet 334 is arranged in the space between the retroreflector 5 and the video display apparatus 1 without being affixed to the retroreflector 5, the video light control sheet 334 has a thickness of about 0.2 mm and is thin or light. Accordingly, in order to hold the video light control sheet 334 on the space, a member that holds the video light control sheet 334 such as a frame or a support made of resin may be appropriately provided.

<Second Configuration Example of Retroreflection Optical System Forming Air floating video Information Display System>

FIG. 7 is a diagram illustrating a configuration of a principal part of a retroreflective optical system in another example for implementing the air floating video information display system according to the embodiment of the present invention. The air video information display system is a system suitable for a viewing person to observe an air floating video obliquely from above. A video display apparatus 1 is configured to include a liquid crystal display panel 11 as a video display element and a light source apparatus 13 that generates light with a specific polarized wave having a narrow-angle diffusion property. The liquid crystal display panel 11 is composed of a liquid crystal display panel having a screen size ranging from a small screen size of about 5 inches to a large screen size exceeding 80 inches. Video light from the liquid crystal display panel 11 is emitted toward a retroreflector (retroreflection portion or a retroreflection plate) 5.

Light from the light source apparatus 13 having a narrow divergence angle, described below, is incident on the liquid crystal panel 11 to generate a video luminous flux having a narrow divergence angle and make the video luminous flux incident on the retroreflector 5, thereby obtaining an air floating image 3. The air floating video 3 is formed at a position symmetric to the video display apparatus 1 with the retroreflector 5 used as a plane of symmetry. In order to erase a ghost image to be generated to obtain a high-quality air floating video 3 at this time, a video light control sheet 334 having a structure illustrated in FIG. 12(A) is provided on the emission side of the liquid crystal panel 11 so that a diffusion property in an unnecessary direction may be controlled. Note that the video light control sheet 334 illustrated in FIG. 7 may be expressed as a diffusion property control sheet. Furthermore, as video light from the liquid crystal panel 11, an S-polarized wave may be used because the reflectance thereof on a reflector such as the retroreflector can be made, in principle, high. However, when the viewing person uses polarized sunglasses, an aerial floating image is reflected or absorbed by the polarized sunglasses. Accordingly, as a countermeasure for this, there is provided a depolarization element 339 that optically converts a part of video light with a specific polarized wave into the other polarized wave and spuriously converts the video light into natural light, so that the viewing person can view a satisfactorily air floating video even if he or she uses the polarized sunglasses. These are optically bonded with an adhesive 338, a light reflection surface does not occur, not deteriorating the image quality of the air floating image.

Examples of f commercially available products of the depolarization element include COSMO SHINE SRF (manufactured by TOYOBO CO., LTD.) and Depolarization Adhesive (manufactured by Nagase & Co., Ltd.). For the COSMO SHINE SRF (manufactured by TOYOBO CO., LTD.), an adhesive is bonded onto an image display apparatus to reduce reflection on an interface therebetween, thereby making it possible to improve an illuminance. Further, when the depolarization adhesive is used, a colorless and transparent plate and an image display apparatus are affixed to each other with the depolarization adhesive interposed therebetween. The video light control sheet 334 is also provided on a video emission surface of the retroreflector 5, to erase ghost images to be respectively generated on both sides of a regular image of the air floating video 3 due to unnecessary light. In this example, the retroreflector 5 is arranged to be parallel to a horizontal plane on a space and is configured such that the air floating video 3 can be displayed to be inclined by θ1 with respect to the horizontal plane. Accordingly, the video display apparatus 1 is configured such that its display surface is inclined by θ1 toward the opposite side to the air floating video 3 with respect to the horizontal plane. Furthermore, in this example, the video display apparatus 1 includes the liquid crystal display panel 11 and the light source apparatus 13 that generates light with a specific polarized wave having a narrow-angle diffusion property.

<Third Configuration Example of Retroreflection Optical System Forming Air floating video Information Display System>

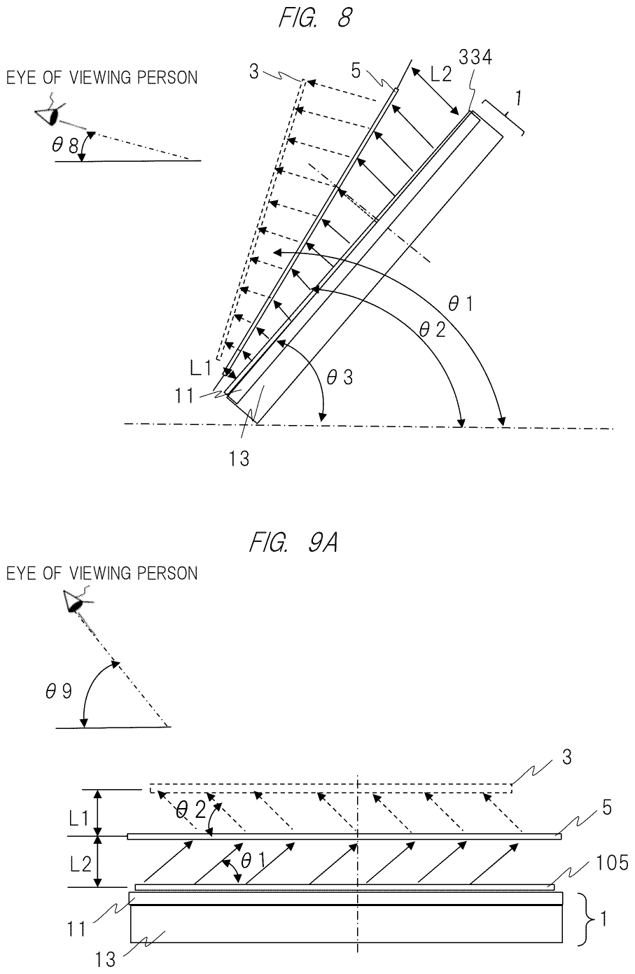

FIG. 8 is a diagram illustrating a configuration of a principal part of a retroreflective optical system in another example for implementing the air floating video information display system. The spatial video information display system is a system suitable for a viewing person to observe an air floating video from the front and obliquely from above. A video display apparatus 1 is configured to include a liquid crystal display panel 11 as a video display element and a light source apparatus 13 that generates light with a specific polarized wave having a narrow-angle diffusion property. The liquid crystal display panel 11 is composed of a liquid crystal display panel having a screen size ranging from a small screen size of about 5 inches to a large screen size exceeding 80 inches.

Video light from the liquid crystal display panel 11 is emitted toward a retroreflector 5. Light from the light source apparatus 13 having a narrow divergence angle, described above, is incident on the liquid crystal panel 11, to generate a video luminous flux having a narrow divergence angle and make the video luminous flux incident on the retroreflector 5, thereby obtaining an air floating image 3. The air floating video 3 is formed at a position symmetric to the video display apparatus 1 with the retroreflector 5 used as a plane of symmetry.

In order to erase a ghost image to be generated in the air floating image 3 to obtain a high-quality air floating video 3, a video light control sheet 334 is provided on the emission side of the liquid crystal panel 11 illustrated in FIG. 12A so that a diffusion property in an unnecessary direction may be controlled. On the other hand, a video light control sheet 334 is also provided on a video emission surface of the retroreflector 5, as illustrated in FIG. 12(B), so that ghost images to be respectively generated on both sides of a regular image of the air floating video 3 due to unnecessary light may be erased. Here, the video light control sheet 334 may also be expressed as a diffusion property control sheet. The retroreflective sheet 5 is inclined (by θ2) with respect to a horizontal plane so that the air floating image 3 can be generated at an angle θ1 with respect to the horizontal plane. Accordingly, when the configuration illustrated in FIG. 8 is incorporated into an upper portion of a KIOSK terminal, for example, to display an air floating video as an avatar on an upper end portion of the terminal, video light is directed to the eyes of a viewing person, so that the high-luminance air floating video can be viewed.

In order to obtain the air floating video 3 at a desired elevation angle and position, an angle of inclination θ2 of the retroreflector 5, an angle of inclination θ3 of the video display apparatus 1, and their respective positions may be optimally designed, like in the first and second examples.

<Fourth Configuration Example of Retroreflection Optical System Forming Air floating video Information Display System>

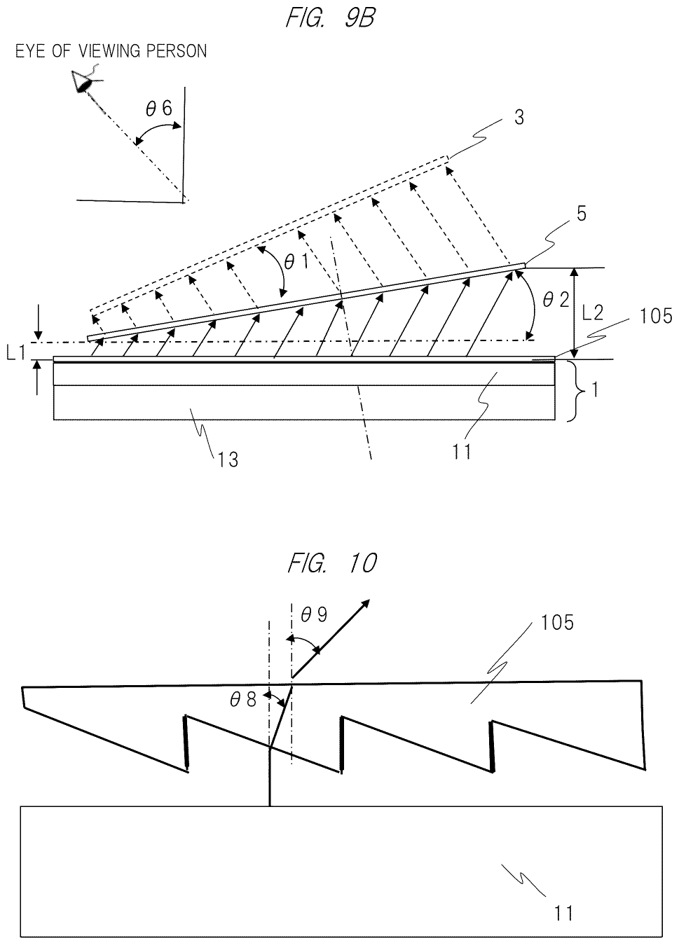

FIG. 9A is a diagram illustrating a configuration of a principal part of a retroreflective optical system in another example for implementing the air floating video information display system. The air video information display system is a system suitable for a viewing person to observe an air floating video obliquely from above. A video display apparatus 1 is configured to include a liquid crystal display panel 11 as a video display element and a light source apparatus 13 that generates light with a specific polarized wave having a narrow-angle diffusion property. The liquid crystal display panel 11 is composed of a liquid crystal display panel having a screen size ranging from a small screen size of about 5 inches to a large screen size exceeding 80 inches.

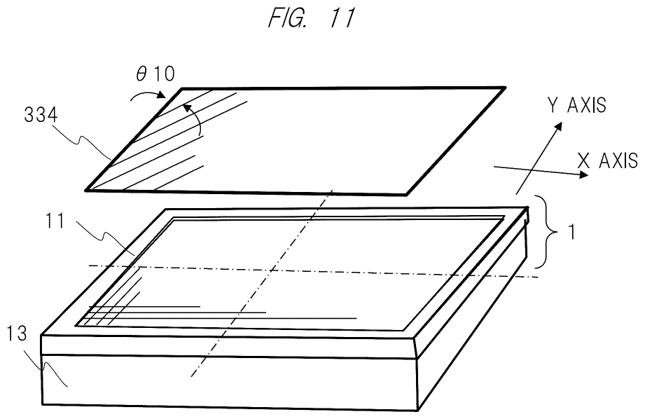

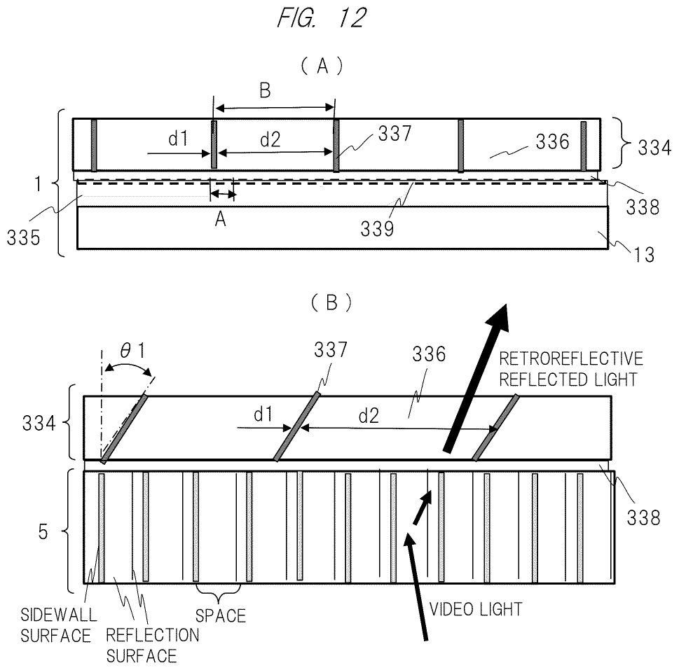

In order to make video light from the liquid crystal display panel 11 obliquely incident on a retroreflector 5 arranged at an opposing position, as illustrated in FIG. 9A, a linear fresnel sheet 105 as illustrated in FIG. 10 may be arranged close to a video light emission surface of the liquid crystal display panel 11 in the video display apparatus 1 to refract the video light in a desired direction. A convex and concave portion is formed on a front surface of the linear fresnel sheet 105 illustrated in FIG. 10. In this example, zigzag-like-shaped or mountain-shaped grooves each having an inclined portion are formed. The front surface of the linear fresnel sheet 105 is a surface opposing the liquid crystal display panel 11. The linear fresnel sheet 105 having such a shape transmits light, so that the light is refracted. When light is incident on the inclined portion of the mountain-shaped groove, the light is emitted at a predetermined angle of refraction. The linear fresnel sheet 105 has the convex and concave portion on a surface opposing the liquid crystal display panel 11. In FIG. 10, light from the liquid crystal display panel 11 is incident from the groove side of the linear fresnel sheet 105, is refracted at an angle θ8, and is emitted at an angle θ9. Note that the linear fresnel sheet 105 illustrated in FIG. 9A may be expressed as a luminous flux traveling direction change member or a luminous flux traveling direction change sheet. At this time, a light shielding layer is provided on a vertical surface of the linear fresnel to block incidence of the video light from other than the fresnel lens, thereby making it possible to prevent unnecessary light from being generated. Furthermore, antireflection films are respectively provided on video light emission and incidence surfaces of the linear fresnel sheet to prevent unnecessary light from being generated, thereby making it possible to obtain a good property.

Light is emitted toward the retroreflector 5 by the above-described linear fresnel sheet 105. Light from the light source apparatus 13 having a narrow divergence angle, described below, is incident on the liquid crystal panel 11 to generate a video luminous flux having a narrow divergence angle and make the video light flux incident on the retroreflector 5, thereby obtaining an air floating image 3. The air floating image 3 is formed at a position symmetric to a display surface of the video display apparatus 1 with a retroreflector 2 used as a plane of symmetry. In this example, the retroreflector 2 and the video display apparatus 1 are respectively arranged at opposing positions. Accordingly, when the viewing person looks into the retroreflector 5 in the air floating video information display apparatus, a video displayed on the liquid crystal panel 11 overlaps the air floating video, thereby significantly reducing the image quality of the air floating video.

In order to prevent the above-described video light from overlapping the air floating video, a video light control sheet 334 is provided on the video light emission surface of the liquid crystal panel 11. A view/light path control film (VCF) manufactured by Shin-Etsu Polymer Co., Ltd., for example, is suitable as the video light control sheet 334, and its structure is a sandwich structure obtained by alternately arranging transparent silicone and black silicone and arranging synthetic resin on a light incidence/emission surface, thereby making it possible to expect a similar effect to that of the external light control film in this example. At this time, in the view/light path control film (VCF), transparent silicone and black silicone each extending in a predetermined direction are alternately arranged. Accordingly, the view/light path control film (VCF) may be arranged to reduce moire to be generated by pixels on the liquid crystal panel 11 and a pitch of the external light control film by inclining respective extension directions of transparent silicone and black silicone in the video light control sheet 334 (by θ10 in the drawing) in an up-down direction of an array direction of the pixels, as illustrated in FIG. 11.

In the fourth example, the retroreflector 5 is arranged parallel to a bottom surface of a housing. This results in a deterioration in the image quality of the air floating video 3 to be generated when external light is incident on the retroreflector 5 to enter the housing. In order to erase a ghost image to be generated in the air floating image 3 to obtain a high-quality air floating video 3, the video light control sheet 334 is provided on the emission side of the liquid crystal panel 11 so that a diffusion property in an unnecessary direction may be controlled, as illustrated in FIGS. 12A and 12B, like in the second and third examples. On the other hand, the video light control sheet 334 is also provided on a video emission surface of the retroreflector 5 so that ghost images to be respectively generated on both sides of a regular image as the air floating video 3 due to unnecessary light may be erased. Here, the video light control sheet 334 may also be expressed as a diffusion property control sheet. A structure described above is arranged inside the housing to prevent external light from being incident on the retroreflector 5, thereby preventing ghost images from being generated.

<Fifth Configuration Example of Retroreflection Optical System Forming Air floating video Information Display System>

Here, in the retroreflection optical systems used to respectively implement the air floating video information display systems illustrated in FIGS. 6 to 8, an angle formed between the video display apparatus 1 and the second retroreflector 5 is an angle θ2 in the example illustrated in FIG. 6A, for example. When the angle θ2 is 10 degrees, video light emitted from the video display apparatus 1 is incident on the second retroreflector 5 at an angle of incidence (an angle formed between a line perpendicular to the second retroreflector 5 and incident light) of 10 degrees, and the video light is reflected by a micromirror formed inside the retroreflector 5 to form the air floating video 3 at a position plane-symmetric to a display surface of the video display apparatus 1 with respect to the retroreflection member 5, that is, a position at an angle of 10 degrees (=θ1) with respect to the retroreflector 5.

At this time, as can be seen from an internal configuration of the retroreflector 5 illustrated in FIG. 2, when video light emitted from the video display apparatus 1 is incident on the second retroreflector 5 at an angle of incidence of 45 degrees, the incident video light is most efficiently reflected, that is, the loss of a light amount is minimum, thereby obtaining a most desirable configuration.

However, when an angle formed between the video display apparatus 1 and the second retroreflector 5, i.e., an angle θ2 is set to a smaller value in order to thin the air floating video display system, as described above, video light emitted from the video display apparatus 1 is incident on the second retroreflector 5 at an angle of incidence of 10 degrees when the angle θ2 is 10 degrees in the example illustrated in FIG. 6A, for example, thereby making it possible to achieve thinning of the air floating video display system, while the utilization efficiency of the video light decreases, resulting in a significant decrease in the luminance of the air floating video 3 to be formed. Specifically, there occurs a problem that the luminance of the air floating video 3 to be formed decreases to one-fifth to one-fourth that when video light emitted from the video display apparatus 1 is incident on the second retroreflector 5 at an angle of incidence of 45 degrees.

An angle formed between the video display apparatus 1 and the second retroreflector 5, i.e., an angle θ2=10 degrees, which is essential to thin the air floating video display system, needs to be maintained. Accordingly, a solution to implement a configuration in which video light emitted from the video display apparatus 1 is incident on the second retroreflector 5 at an angle of incidence as close to 45 degrees as possible has been studied. If this can be implemented, the luminance of the air floating video 3 finally formed can increase to four times to five times those in the examples illustrated in FIGS. 6 to 8, thereby making it possible to obtain an air floating video 3 that is brighter and excellent in visibility with the air floating video display system itself having a thin shape.

FIG. 9B is a diagram illustrating a specific solution to the above-described problems. FIG. 9B is a diagram illustrating an example in which the linear fresnel sheet 105 is arranged, for example, on the display screen of the video display apparatus 1. In order to make video light from the liquid crystal display panel 11 obliquely incident on the retroreflector 5, the linear fresnel sheet 105, as illustrated in FIG. 10, is arranged close to a video display surface of the liquid crystal display panel 11 in the video display apparatus 1 so that the video light may be refracted in a desired direction. Note that the linear fresnel sheet 105 may be expressed as a luminous flux traveling direction change member or a luminous flux traveling direction change sheet.

When the linear fresnel sheet 105 is arranged on a front surface of the video display apparatus 1, as illustrated in FIG. 9B, an angle of video light to be emitted from the video display apparatus 1, i.e., an angle of incidence on the second retroreflector 5 can be changed. The linear fresnel sheet 105 is arranged on an emission surface of the liquid crystal display panel 11 in the video display apparatus 1 or a front surface of the liquid crystal display panel 11 in the video display apparatus 1. For example, in FIG. 9B, in the video light emitted from the video display apparatus 1, a direction of light rays to be incident on the retroreflector 5 from the video display apparatus 1 is bent by 30 degrees by the linear fresnel sheet 105. That is, an angle formed between the video display apparatus 1 and the light rays to be incident on the retroreflector 5 is 30 degrees. As a result, an angle of incidence at which the video light is incident on the second retroreflector 5 is 40 degrees. Therefore, when the linear fresnel sheet 105 is arranged, the angle of incidence on the second retroreflector 5 is close to 45 degrees as an ideal angle. Accordingly, the luminance of the air floating video 3 formed by a configuration illustrated in FIG. 9B is improved by about three or four times that in the configuration illustrated in FIG. 6A.

Here, as illustrated in FIG. 9B, when the air floating video display system is arranged on a desk for the viewing person of the air floating video, the viewing person looks down the air floating video 3 at an angle θ6, like in the configuration illustrated in FIG. 6A. At this time, an image forming position of the air floating video 3 is an optimal arrangement in which the air floating video is viewed by being arranged such that an angle θ2 formed between the display surface of the video display apparatus 1 and the retroreflector 5 and an angle θ1 formed between the retroreflector 5 and the air floating video 3 are substantially equal to each other, i.e., θ1=θ2. As described above, the fifth configuration of the retroreflection system makes it possible to solve the problem that the luminance of the air floating video 3 decreases while implementing thinning of the air floating video display system.

<First Configuration Example of Air floating video Information Display System>

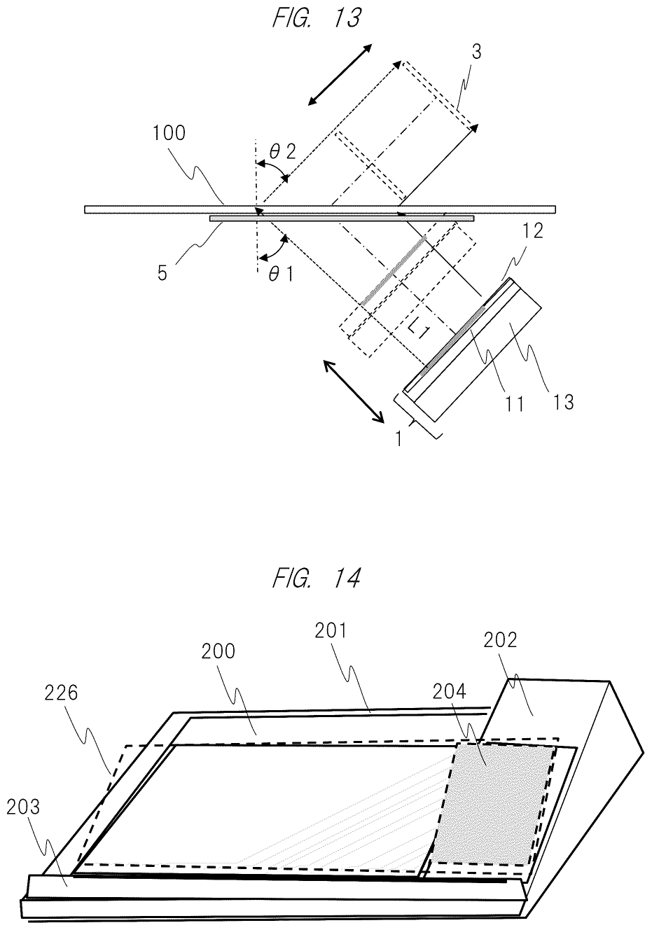

A first example of the air floating video information system using the above-described four retroreflection optical systems is illustrated in FIG. 13. A retroreflector 5 is fixed by adhesion or fixed by bonding to a transparent sheet 100. A structure in which an image forming position of an air floating video 3 can be varied is used as a structure in which a distance between a video display apparatus 1 and the retroreflector 5 can be varied so that a movement can be provided to the air floating video, thereby making it possible to implement a video information display apparatus capable of spuriously displaying a three-dimensional air floating video.

<Second Configuration Example of Air floating video Information Display System>

A second example of the air floating video information display system will be described with reference to FIG. 14. FIG. 14 illustrates an example in which an air floating video display apparatus 202 is incorporated into a tablet terminal. The air floating video display apparatus 202 and a planar display 200 are provided in the same housing 201, and a sensing unit 203 that covers the planar display 200 and the whole of a display image 204 on the spatial floating video display 202 is provided at respective starting points of the planar display 200 and the air floating video 204 in the same plane as the air floating video 204, and is provided in the same plane like a sensing area 226. If the number of sensing areas described above is two or more, the sensing areas may respectively exist in parallel with or in front of or behind each other on planes, or may exist in the same plane. The air floating video display apparatus 202 and the planar display 200 may be together installed in the same housing 201. Although description is made using the planar display 200 in the present embodiment, not only the planar display but also a display may be used. In the second configuration example, the sensing area increases in height toward the back side from a front surface of the apparatus, and has a slope. This implements an easy-to-input arrangement. The sensing unit will be described in detail below.

The video information display system is not easily affected by external light when the wavelength of light source light of a TOF system as a distance measurement system of the sensing unit 203 to be used is a long wavelength of 900 (nm) or more. At this time, a user falsely feels as if a spatial operation input to be performed for the displayed air floating video 204 can be similarly performed for a video display surface of the planar display 200. Accordingly, the user can perform the spatial operation input without directly touching a display surface of the planar display 200.

Furthermore, the inventors have found out by an experiment to what extent the planar display 200 and the sensing area 226 may be spaced apart from each other for an operator's finger not to touch a front surface of the planar display 200 even if an operator performs a spatial operation on the basis of a screen displayed on the planar display 200. As a result, it has been found out by the experiment that a possibility that the operator directly touches the screen of the planar display 200 can be set to 50% or less by spacing an image forming position of the air floating video 204 by 40 mm or more apart from the planar display 200. Furthermore, when the image forming position is spaced by 50 mm or more, the operator does not directly touch the planar display 200.

Note that the configuration illustrated in FIG. 14 may be incorporated into not only the tablet terminal but also various types of display apparatuses such as an ATM, an automatic ticketing machine, a KIOSK terminal, and a stationary display apparatus.

<Third Configuration Example of Air floating video Information Display System>

A third example of the air floating video information display system will be described with reference to FIG. 15. FIG. 15 illustrates an example in which an air floating video display apparatus 202 is incorporated into a tablet terminal. The air floating video display apparatus 202 and a planar display 200 are provided in the same housing 201. There are a first sensing unit 203a that senses a first sensing area (sensing region) 226a that covers an image forming area of an air floating video 204 in the air floating video display apparatus 202 and a second sensing unit 203b that senses a second sensing area 226b that covers an image display area of the planar display 200. The first sensing area 226a and the second sensing area 226b are respectively provided at starting points of the air floating video display apparatus 202 and the planar display 200. Further, the first sensing area 226a and the second sensing area 226b are arranged close to each other. The first sensing area and the second sensing area exist in parallel with or in front of or behind each other, respectively, on planes. As illustrated in FIG. 15, the first sensing area and the second sensing area may be configured to exist in the same plane. The air floating video display apparatus 202 and the planar display 200 may be together installed in the same housing 201. Although description is made using the planar display 200 in the present embodiment, not only the planar display but also a display may be used. In this example, the air floating video display apparatus 202 is arranged substantially parallel to an image display surface of the planar display 200. The sensing units used here will be described in detail below.

In the third example of the video information display system described above, a user falsely feels as if a spatial operation input to be performed for the displayed air floating video 204 can also be similarly performed for the video display surface of the planar display 200. Accordingly, the user can perform the spatial operation input without directly touching a display screen of the planar display 200.

At this time, as a result of evaluating a touch of a finger on a planar display 200 in a trial product using an actual machine, when an image forming position of an air floating video 204 is spaced by 50 mm or more apart from a planar display 200, an operator could perform a spatial operation input to a video information display system without directly touching a screen of the planar display 200.

Note that the configuration illustrated in FIG. 15 may be incorporated into not only the tablet terminal but also various types of display apparatuses such as an ATM, an automatic ticketing machine, a KIOSK terminal, and a stationary display apparatus.

### <Technical Means for Sensing Air Video>

A sensing technique for spuriously operating an air floating video for a viewing person (operator) to be bidirectionally connected to an information system via an air floating video display apparatus will be described below.

In an air floating video information system, sensing information together with the air floating video is read by a two-dimensional sensor described below, thereby making it possible to perform an image operation for a display video.

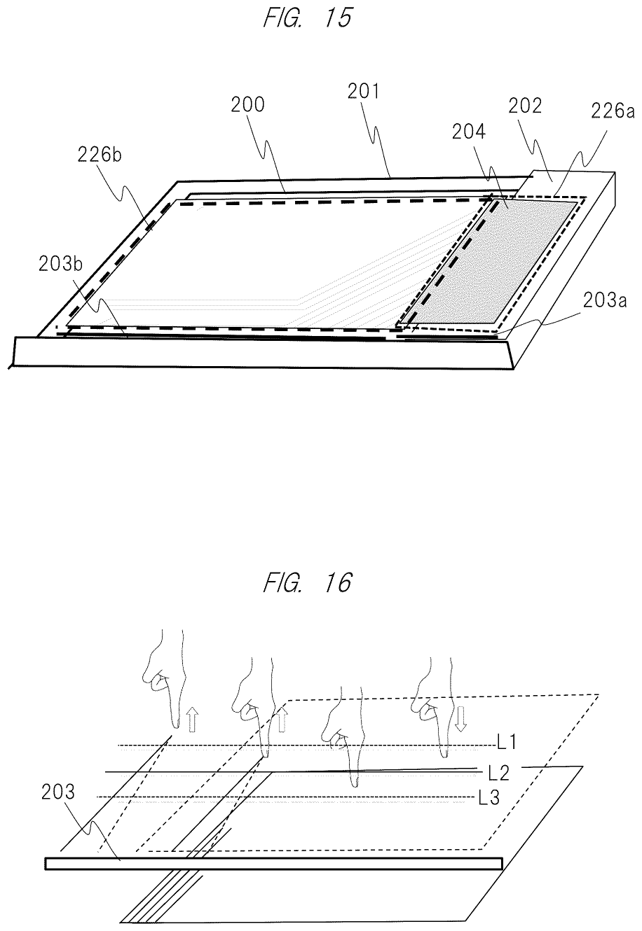

The sensing technique for spuriously operating the air floating video in order for the viewing person (operator) to be bidirectionally connected to the information system via the air floating video display apparatus will be described below. FIG. 16 is a principle diagram for illustrating the sensing technique. There is provided a distance measurement apparatus 203 that contains a TOF (time of flight) system corresponding to the air floating video. A near-infrared LED (light emitting diode) as a light source is made to emit light in synchronization with a signal from the system. An optical element for controlling a divergence angle is provided on the light ray emission side of the LED, and high-sensitivity avalanche diodes each having a picosecond time resolution as a light receiving element are paired and aligned in a transverse direction to correspond to an area. The LED as the light source emits light in synchronization with the signal from the system, and a phase Δt shifts by a time period elapsed until the light is reflected by an object to be distance-measured (a tip of a finger of the viewing person) to return to a light receiving part. A distance of the object is calculated from the time difference Δt, to sense a position and a movement of the finger of the operator as two-dimensional information together with positional information of a plurality of sensors arranged in parallel. Further, it is possible to implement an air floating information display system or an air floating video display apparatus having a sensing function of hardly erroneously detecting a display screen of a planar display and an air floating video.

### <Technical Means for Reducing Ghost Image>

Technical means for implementing a high-quality air video display apparatus in which a ghost image is reduced as an air floating video display apparatus will be described with reference to FIG. 12. In order to control a divergence angle of video light from a liquid crystal panel 13 as a video display element in a desired direction, a video light control sheet 334 may be provided on an emission surface of the liquid crystal panel 13. Furthermore, the video light control sheet 334 is provided on one or both of a light ray emission surface and a light ray incidence surface of a retroreflector to absorb extraordinary light that generates a ghost image.

FIG. 12 illustrates a specific method for applying a video light control sheet 334 to an air video display apparatus. The video light control sheet 334 is provided on an emission surface of a liquid crystal panel 335 as a video display element. At this time, the following two methods are effective to reduce moire to be generated by pixels on a liquid crystal panel 13 and an interference due to a pitch of transmission parts 336 and light absorption parts 337 in the video light control sheet 334.

(1) The video light control sheet 334 is arranged to be inclined by θ10, as illustrated in FIG. 11, with respect to vertical stripes occurring by the transmission part and the light absorption part in the video light control sheet 334 and an array of pixels on the liquid crystal panel 335 (denoted by a liquid crystal panel 11 in FIG. 11).

(2) Letting A be a size of the pixels on the liquid crystal panel 335 and letting B be a pitch of the vertical stripes in the video light control sheet 334, a ratio (B/A) of these is selected to exclude integral multiples.

One pixel 339 on the liquid crystal panel is formed by arranging pixels in three RGB colors in parallel, and is generally square. Accordingly, occurrence of the above-described moire cannot be suppressed on an entire screen. Accordingly, it has been experimentally found out that the inclination θ10 described in (1) may be optimized in a range from 5 degrees to 25 degrees such that an occurrence position of the moire can be arranged while being intentionally shifted to a place where an air floating video is not displayed. The liquid crystal panel has been described as an example to reduce the moire. However, for moire occurring between a retroreflector 5 and the video light control sheet 334, a large moire having a large wavelength and having a frequency low enough to be recognizable even visually can be reduced by optimally inclining the video light control sheet while focusing on an X axis, as illustrated in FIG. 4, because the retroreflector 5 and the video light control sheet 334 are linear structures.

FIG. 12(A) is a vertical sectional view of the video display apparatus 1 according to the invention of the present application in which the video light control sheet 334 is arranged on a video light emission surface of the liquid crystal panel 335. The video light control sheet 334 is configured by alternately arranging the light transmission parts 336 and the light absorption parts 337, and is fixed by adhesion to a video light emission surface of the liquid crystal panel 335 by an adhesive layer 338.

Further, when a WUXGA liquid crystal display panel of 7 inches (1920×1200 pixels) is used as the video display apparatus 1, as described above, even if one pixel (one triplet) (A in the drawing) is about 80 μm, a sufficient transmission property and a diffusion property of video light from the video display apparatus causing generation of extraordinary light are controlled to reduce ghost images to be generated on both sides of the air floating image if a pitch B including a transmission portion d2 of 300 μm and a light absorption portion d1 of 40 μm in the video light control sheet 334 is 340 μm, for example. At this time, if the thickness of the video control sheet is set to two-thirds or more of the pitch B, a ghost reduction effect is significantly improved.

FIG. 12(B) is a vertical sectional view of the retroreflector according to the invention of the present application in which the video light control sheet 334 is arranged on a video light emission surface of the retroreflector 5. The video light control sheet 334 is configured by alternately arranging the light transmission parts 336 and the light absorption parts 337, and is arranged to be inclined at an angle of inclination θ1 to match an emission direction of retroreflected light. As a result, extraordinary light to be generated as the above-described retroreflection occurs is absorbed, while regularly reflected light can be transmitted without any loss.

When the WUXGA liquid crystal display panel of 7 inches (1920×1200 pixels) is used, even if one pixel (one triplet) (A in the drawing) is about 80 μm, a sufficient transmission property and a diffusion property of video light from the video display apparatus causing generation of extraordinary light in the retroreflector are controlled to reduce ghost images to be generated on both sides of the air floating image if a pitch B including a transmission portion d2 of 400 μm and a light absorption portion d1 of 20 μm in the retroreflector is 420 μm, for example.

On the other hand, the above-described video light control sheet 334 prevents external light from the outside world from entering the air floating video display apparatus, thereby also leading to an improvement in reliability of components. A view/light path control film (VCF) manufactured by Shin-Etsu Polymer Co., Ltd., for example, is suitable as the video light control sheet, and its structure is a sandwich structure obtained by alternately arranging transparent silicone and black silicone and arranging synthetic resin on a light incidence/emission surface, thereby making it possible to expect a similar effect to that of the external light control film in this example.

### <Performance of Liquid Crystal Panel>

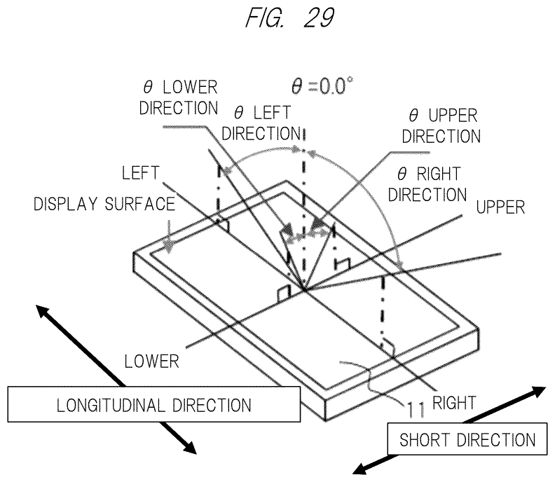

Meanwhile, a general TFT (thin film transistor) liquid crystal panel differs in luminance and contrast performance depending on a mutual property of a liquid crystal and a light polarization plate based on a light emission direction. In an evaluation in a measurement environment illustrated in FIG. 29, as a property of a luminance and a viewing angle in a panel short-side (up-down) direction, a property (+5 degrees in this example) at an angle slightly shifting from an emission angle perpendicular to a panel surface (an emission angle of 0 degrees) is excellent, as illustrated in FIG. 31. This is because a light twisting property is not 0 degrees when an applied voltage is maximum in the short-side (up-down) direction of the liquid crystal panel.

On the other hand, a contrast performance in the panel short-side (up-down) direction is excellent in a range from −15 degrees to +15 degrees, as illustrated in FIG. 33, and its most excellent property is obtained in use in a range of +10 degrees around 5 degrees when combined with a luminance property.

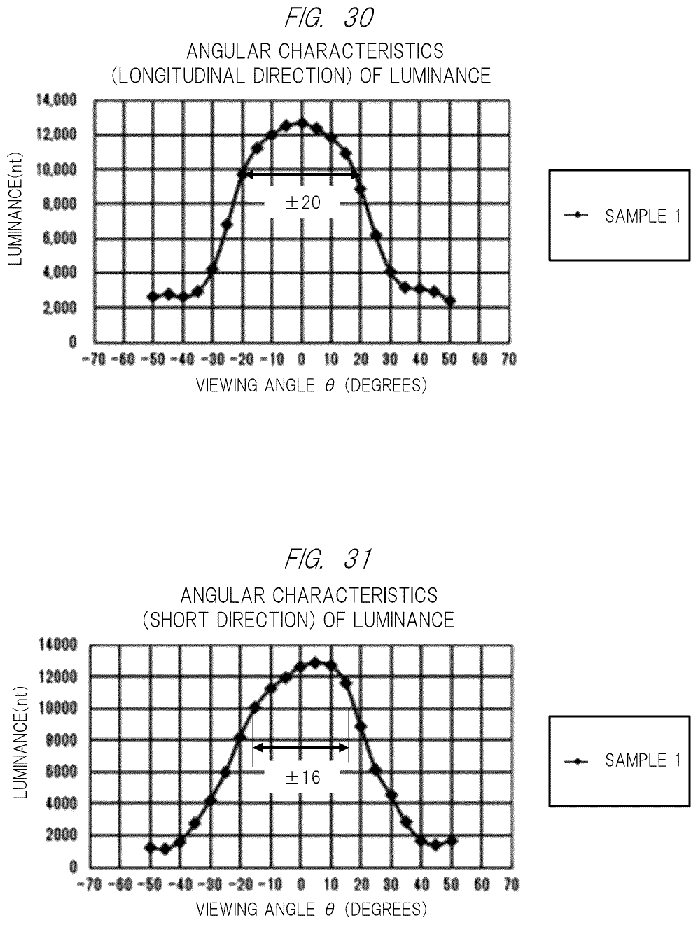

As a property of a luminance and a viewing angle in a panel long-side (left-right) direction, a property at an emission angle perpendicular to a panel surface (an emission angle of 0 degrees), as illustrated in FIG. 30, is excellent. This is because a light twisting property is 0 degrees when an applied voltage is maximum in the long-side (left-right) direction of the liquid crystal panel.

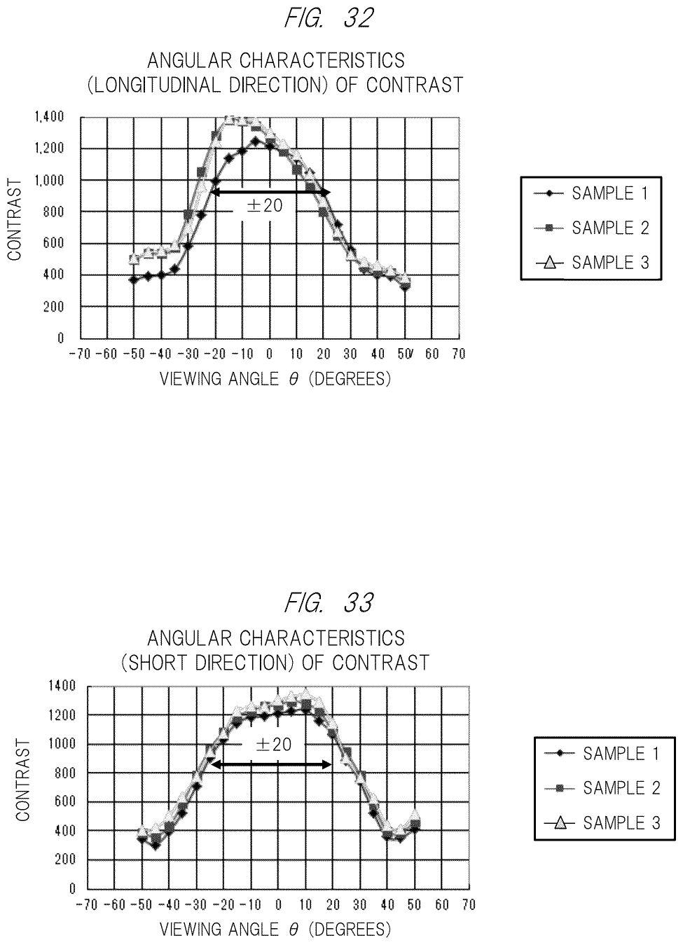

Similarly, a contrast performance in the panel long-side (left-right) direction is excellent in a range from −5 degrees to −10 degrees, as illustrated in FIG. 32, and its most excellent property is obtained in use in a range of +5 degrees around −5 degrees when combined with a luminance property. Accordingly, an emission angle of video light to be emitted from the liquid crystal panel improves an image quality and a performance of the video display apparatus 1 by making light incident on a liquid crystal panel in a direction in which a most excellent property is obtained by luminous flux direction conversion means (reflection surfaces 307 and 314, etc.) provided in a light guiding body of the light source apparatus 13, described above, and modulating the light in response to a video signal.

In order to maximize the luminance and the contrast property of the liquid crystal panel as a video display element, light incident on the liquid crystal panel from a light source is set to the above-described range so that a video quality of an air floating video can be improved.

### <Method for Controlling Light Source Light>

In the present embodiment, in the video display apparatus 1 configured by including the light source apparatus 13 and the liquid crystal display panel 11 in order to improve the utilization efficiency of a luminous flux emitted from the light source apparatus 13 and significantly reduce power consumption, a video light ray, the luminance of which is modulated in response to a video signal, after being incident on the liquid crystal panel 11 at such an angle of incidence that a property of the liquid crystal panel 11 is maximum from the light source apparatus 13 and is emitted toward a retroreflector. At this time, it is desired to increase the degree of freedom of an arrangement of the liquid crystal panel 11 and the retroreflector in order to reduce a set volume of the air floating video information display system. Furthermore, the following technical means is used to form a floating video at a desired position and ensure an optimal directionality after retroreflection.

A transparent sheet composed of an optical component such as a linear fresnel lens illustrated in FIG. 10 as a light direction conversion panel is provided on a video display surface of the liquid crystal panel 11, to control an emission direction of a luminous flux incident on a retroreflective optical member with a high directionality provided thereto and determine an image forming position of the air floating video. Accordingly, video light from the video display apparatus 1 efficiently reaches an observer, like laser light, with a high directionality (straightness). As a result, it is possible to display a high-quality floating video with a high resolution and to significantly reduce power consumption by the video display apparatus 1 including the light source apparatus 13.

### <Example 1 of Video Display Apparatus>

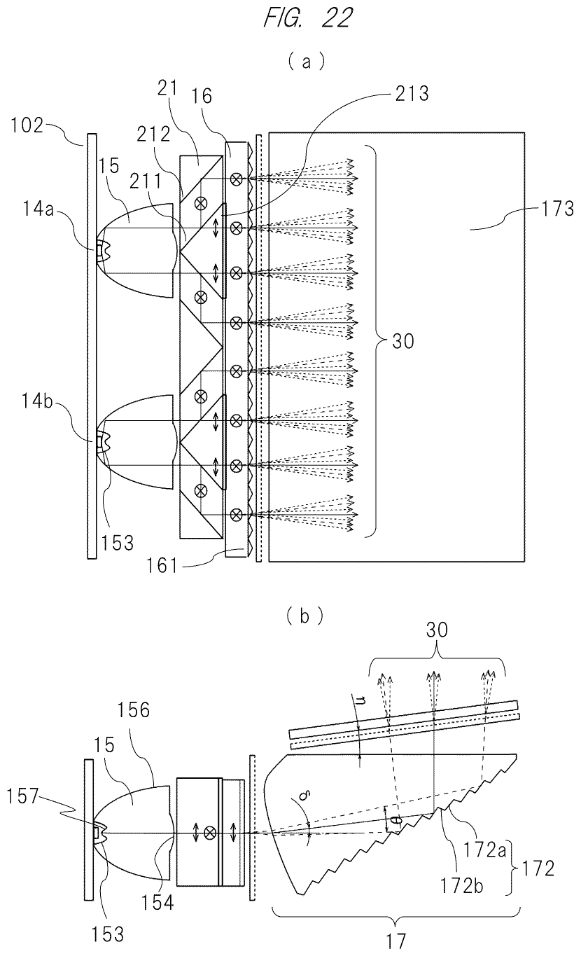

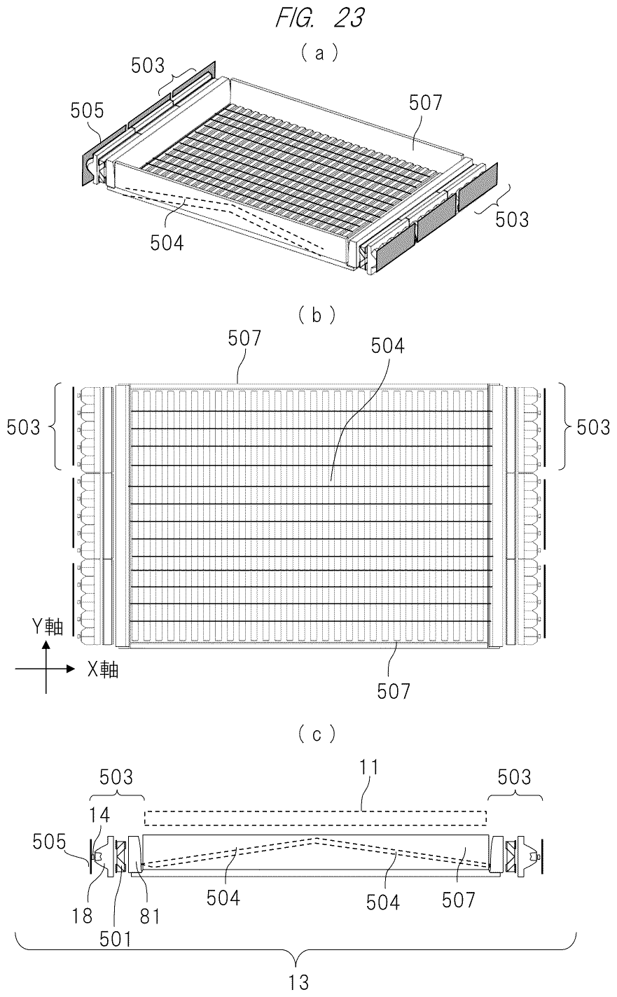

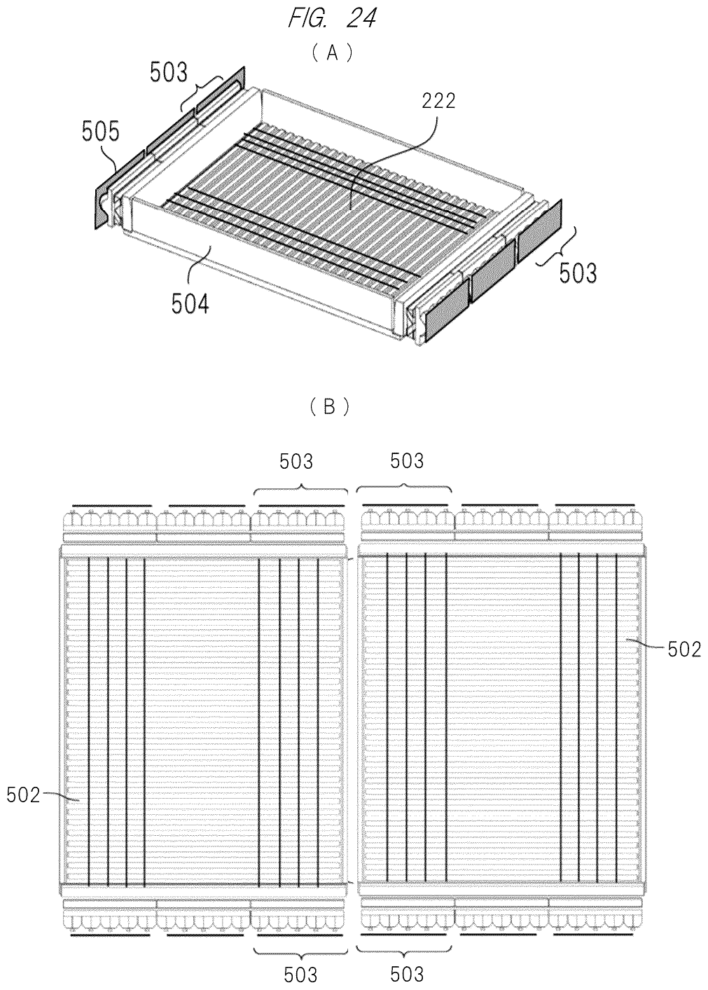

FIG. 22 illustrates another example of a specific configuration of a video display apparatus 1. A light source apparatus 13 illustrated in FIG. 22 is similar to a light source apparatus illustrated in FIG. 23 or the like. The light source apparatus 13 is configured by housing an LED, a collimator, a composite diffusion block, a light guiding body, and the like in a case made of plastic, for example, and a liquid crystal display panel 11 is attached to its upper surface. Further, LED (light emitting diode) elements 14a and 14b as semiconductor light sources and an LED substrate on which a control circuit for the elements is mounted are attached to one side surface of the case of the light source apparatus 13, and a heat sink as a member for cooling heat to be generated by the LED elements and the control circuit is attached to an outer side surface of an LED substrate (not illustrated).

Further, a liquid crystal display panel frame attached to an upper surface of the case is configured by having the liquid crystal display panel 11 attached to the frame, further FPC (flexible printed circuits) (not illustrated) electrically connected to the liquid crystal display panel 11, and the like attached thereto. That is, the liquid crystal display panel 11 as a liquid crystal display element, together with the LED elements 14a and 14b as solid light sources, modulates the intensity of transmitted light, thereby generating a display video, on the basis of a control signal from a control circuit (not illustrated here) constituting an electronic apparatus.

### <Example 1 of Light Source Apparatus in Example 1 of Video Display Apparatus>

Then, a configuration of an optical system such as the light source apparatus housed in the case will be described in detail with reference to FIGS. 22 (a) and 22 (b) together with FIG. 21. In FIGS. 21 and 22, the LEDs 14a and 14b constituting the light source are illustrated, and are respectively attached to predetermined positions relative to collimators 15. Note that each of the collimators 15 is formed of light transmittable resin such as acrylic resin. Then, the collimator 15 has an outer peripheral surface 156 having a conically convex shape obtained by rotating a paraboloidal cross section, and has a concave portion 153 having a convex portion (e.g., a convex lens surface) 157 in a central portion of its apex portion (the side contacting the LED substrate), as also illustrated in FIG. 22 (b).

Further, a planar portion (the opposite side to the above-described apex portion) of the collimator 15 has a convex lens surface protruding outward (or may be a concave lens surface recessed inward) 154 in its central portion. Note that the paraboloidal surface 156 forming the outer peripheral surface having a conical shape of the collimator 15 is set within a range of an angle at which light to be emitted in a circumferential direction from the LEDs 14a and 14b can be totally reflected by its inside, or has a reflection surface formed thereon.

Further, each of the LEDs 14a and 14b is arranged at a predetermined position on a surface of a substrate 102 as its circuit board. The substrate 102 is arranged on and fixed to the collimator 15 such that the LED 14a or 14b on the surface is positioned in a central portion of the concave portion 153.

According to such a configuration, among lights to be radiated from the LED 14a or 14b by the above-described collimator 15, particularly the light to be radiated upward (in a rightward direction in the drawing) from the central portion of the collimator 15 is collected into collimated light by the two convex lens surfaces 157 and 154 forming an outer shape of the collimator 15. Further, the light to be emitted in a circumferential direction from the other portion is reflected by the paraboloidal surface forming the outer peripheral surface having the conical shape of the collimator 15, and is similarly collected into collimated light. In other words, the collimator 15 having a convex lens formed in its central portion and a paraboloidal surface formed in its peripheral portion makes it possible to extract almost all of the lights generated by the LED 14a or 14b as collimated light and to improve the utilization efficiency of the generated lights.

Note that a polarization conversion element 21 is provided on the light emission side of the collimator 15. The polarization conversion element 21 may be referred to as a polarization conversion member. The polarization conversion element 21 is configured by combining a light transmittable member having a shape of a prism that is a parallelogram in cross section (hereinafter referred to as a parallelogram prism) and a light transmittable member having a shape of a prism that is a triangle in cross section (hereinafter referred to as a triangle prism) and arranging a plurality of light transmittable members in an array parallel to a surface perpendicular to an optical axis of the collimated light from the collimator 15, as also apparent from FIG. 22 (a). Furthermore, polarization beam splitters (hereinafter abbreviated as “PBS films”) 211 and reflection films 212 are alternately provided on an interface between the adjacent light transmittable members arranged in an array, and an emission surface, from which light that has been incident on the polarization conversion elements 21 and transmitted by the PBS film 211 is emitted, is provided with a λ/2 phase plate 213.

The emission surface of the polarization conversion element 21 is further provided with a composite diffusion block 16 having a rectangular shape, as also illustrated in FIG. 22 (a). That is, lights emitted from the LED 14a or 14b are incident on the composite diffusion block 16 as collimated light by the function of the collimator 15, and are diffused by a texture 161 on the emission side, to reach a light guiding body 17.

The light guiding body 17 is a member formed of light transmittable resin such as acrylic resin into a shape of a bar that is substantially triangular in cross section (see FIG. 23 (b)), and includes a light guiding body light incidence part (surface) 171 opposing an emission surface of the composite diffusion block 16 with a first diffusion plate 18a interposed therebetween, a light guiding body light reflection portion (surface) 172 forming an inclined surface, a light guiding body light emission part (surface) 173 opposing the liquid crystal display panel 11 as a liquid crystal display element with a second diffusion plate 18b interposed therebetween, as also apparent from FIG. 25.

On the light guiding body light reflection part (surface) 172 in the light guiding body 17, a large number of reflection surfaces 172a and connection surfaces 172b are alternately formed in a serrated shape, as also illustrated in FIG. 23 as its partial enlarged view. Then, the reflection surface 172a (a right upward line in the drawing) forms an (n: a natural number, e.g., 1 to 130 in this example) with respect to a horizontal surface indicated by a one-dot and dash line in the drawing. Here, an is set to 43 degrees or less (but 0 degrees or more) as an example.

The light guiding body incidence part (surface) 171 is formed into a curved convex shape inclined toward the light source side. Accordingly, collimated light from the emission surface of the composite diffusion block 16 is diffused through the first diffusion plate 18a and is incident on the light guiding body incidence part (surface) 171, to reach the light guiding body light reflection portion (surface) 172 while being slightly bent (deflected) upward by the light guiding body light incidence part (surface) 171, and is reflected here, to reach the liquid crystal display panel 11 provided on the emission surface on the upper side of the drawing, as also apparent from the drawing.

The video display apparatus 1 described in detail above, including a modularized S-polarized wave light source apparatus, can be manufactured in a small size and at a low cost, simultaneously with more improving the light utilization efficiency and its uniform illumination property. Note that the polarization conversion element 21 is attached to the back of the collimator 15 in the above description, the present invention is not limited to that. Even if the polarization conversion element 21 is provided in an optical path leading to the liquid crystal display panel 11, a similar function and effect can be obtained.

Note that the large number of reflection surfaces 172a and connection surfaces 172b are alternately formed in a serrated shape on the light guiding body light reflection portion (surface) 172, an illumination luminous flux is totally reflected on each of the reflection surfaces 172a to propagate upward, and is further incident on a light direction conversion panel 54 that adjusts a directionality as a substantially collimated diffusion luminous flux by a narrow-angle diffusion plate provided on the light guiding body light emission part (surface) 173, and is incident on the liquid crystal display panel 11 in an oblique direction. Although the light direction conversion panel 54 is provided between the light guiding body emission surface 173 and the liquid crystal display panel 11 in this example, a similar effect is obtained even if provided on the emission surface of the liquid crystal display panel 11.

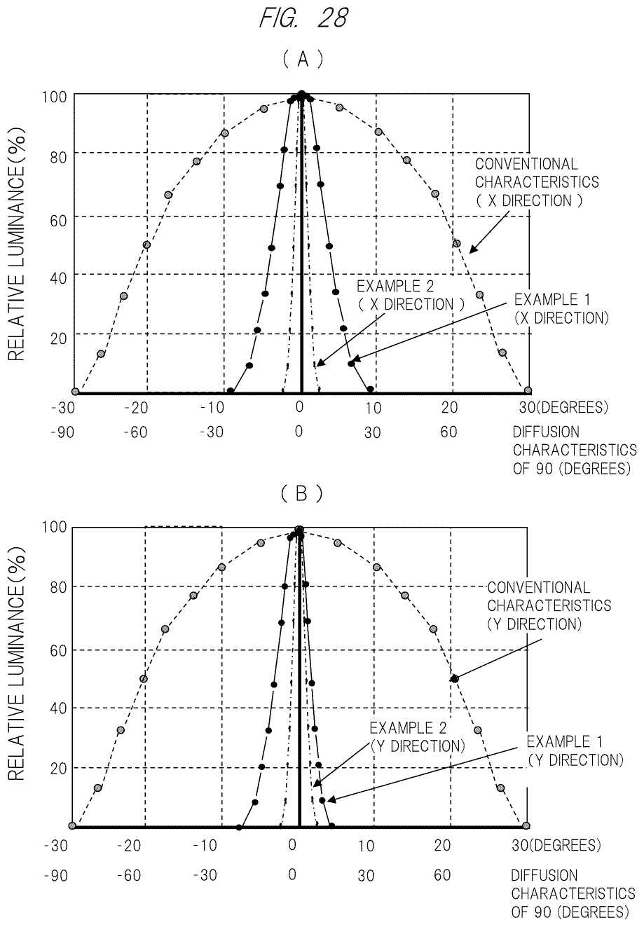

Light emitted from the liquid crystal display panel 11 has similar diffusion properties, respectively, in a screen horizontal direction (a display direction corresponding to an X axis of a graph in FIG. 28(A)) and a screen vertical direction (a display direction corresponding to a Y axis of a graph in FIG. 28(B)), as illustrated in respective plot curves of a “conventional property (X-direction)” in FIG. 28(A) and a “conventional property (Y-direction)” in FIG. 28(B), for example, in a general apparatus for TV use.

On the other hand, a diffusion property of a luminous flux emitted from the liquid crystal display panel in this example is a diffusion property, as illustrated in respective plot curves of an “example 1 (X-direction)” in FIG. 28(A) and an “example 1 (Y-direction)” in FIG. 28(B), for example.

In a specific example, when a viewing angle having a luminance that is 50% (a luminance decreasing to about half) of a luminance in a front view (an angle of 0 degrees) is set to 13 degrees, the viewing angle is an angle that is about one-fifth that of a diffusion property (an angle of 62 degrees) of a general apparatus for household TV use. Similarly, in an example of a case where viewing angles in a vertical direction on the upper side and the lower side are set to be unequal, a reflection angle and an area of a reflection surface of a reflection-type light guiding body, for example, are optimized such that the viewing angle on the upper side is suppressed (narrowed) to about one-third the viewing angle on the lower side.

When the viewing angle and the like are set, as described above, the light amount of a video that propagates in a viewing direction of a user is more significantly increased (significantly improved in terms of brightness of the video) than that and the luminance of the video is 50 times or more that in a conventional liquid crystal TV.

Furthermore, in a case of a viewing angle property illustrated in an “example 2” in FIG. 28, when a viewing angle having a luminance of 50% (a luminance decreasing to about half) of a luminance of a video obtained in a front view (an angle of 0 degrees) is set to 5 degrees, the viewing angle is an angle that is about one-twelfth (a narrow viewing angle) that of a diffusion property (an angle of 62 degrees) of a general apparatus for household TV use. Similarly, in an example of a case where viewing angles in a vertical direction on the upper side and the lower side are set to be equal, a reflection angle and an area of a reflection surface of a reflection-type light guiding body, for example, are optimized such that the viewing angles in the vertical direction are suppressed (narrowed) to about one-twelfth that in the conventional technique.

When such a setting is performed, the luminance (light amount) of a video that propagates in a viewing direction (a line-of-sight direction of a user) is more significantly improved than that and the luminance of the video is 100 times or more that in the conventional liquid crystal TV.

When the viewing angle is set to a narrow angle, as described above, an amount of a luminous flux that propagates in a viewing direction can be concentrated, resulting in a significantly improved light utilization efficiency. As a result, even if a general liquid crystal display panel for TV use is used, a significant improvement in luminance can be implemented with similar power consumption by adjusting a light diffusion property of the light source apparatus, thereby enabling a video display apparatus corresponding to an information display system for bright outdoors.

When a large liquid crystal display panel is used, light on the periphery of a screen is directed inward to propagate toward a viewing person when the viewing person faces the center of the screen, so that a full-screen performance in terms of screen brightness is improved. In FIG. 25, a convergence angle between a long side of the liquid crystal display panel and a short side of the liquid crystal display panel when using a distance L from the liquid crystal display panel to the viewing person and a panel size (a screen ratio 16:10) of the video display apparatus as parameters is found.

A drawing on the upper side of FIG. 25 presupposes a case where a video is viewed such that the screen of the liquid crystal display panel is portrait-oriented (hereinafter also referred to as “vertically-long use”). In this case, the convergence angle may be set to match the short side of the liquid crystal display panel (see a direction indicated by an arrow V in FIG. 25 as needed). As a more specific example, when a viewing distance is 0.8 m in vertically-long use of a 22″ panel, for example, as referred to by a plot graph in FIG. 15, the convergence angle is set to 10 degrees so that video light from each of corners (four corners) of the screen can be effectively projected and outputted toward the viewing person.

Similarly, if the convergence angle is set to 7 degrees when a viewing distance is 0.8 m in the case of viewing in vertically-long use of a 15″ panel, video light from each of four corners of the screen can be effectively caused to propagate toward the viewing person. As described above, video light on the periphery of the screen is caused to propagate toward the viewing person at a position optimal to view the center of the screen depending on the size of the liquid crystal display panel and whether the use is vertically-long use or horizontally-long use, thereby making it possible to improve a full-screen performance in terms of screen brightness.

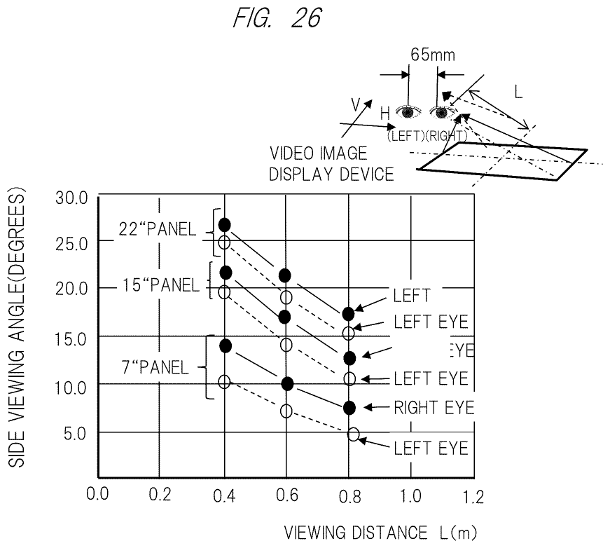

As a basic configuration, when a luminous flux having a narrow-angle directionality is made incident on the liquid crystal display panel 11 by the light source apparatus, as illustrated in FIG. 26, described above, and others, and the luminance thereof is modulated to match a video signal, an air floating video obtained by reflecting video information displayed on the screen of the liquid crystal display panel 11 by a retroreflector is displayed outside or inside a room through a transparent sheet 100.

A plurality of examples will be described below for other examples of the light source apparatus. The other examples of the light source apparatus may be all used in place of the light source apparatus in the above-described example of the video display apparatus.

When the large liquid crystal display panel is used, the light on the periphery of the screen is directed inward to propagate toward the viewing person when the viewing person faces the center of the screen, so that the full-screen performance in terms of screen brightness is improved, as described above. On the other hand, a binocular parallax occurs depending on which of the left and right eyes of the viewing person is used to perform visual recognition. In FIG. 26, a convergence angle between a long side of the liquid crystal display panel and a short side of the liquid crystal display panel when using a distance L from the liquid crystal display panel to the viewing person and a panel size (a screen ratio 16:10) of the video display apparatus as parameters is found using respective positions of the left and right eyes as a reference.

The smaller a panel size is and the closer a viewing distance is, the larger a convergence angle in a binocular view with left and right eyes becomes. Particularly when a small panel of 7 inches or less is used, a convergence angle due to a binocular parallax is an important requirement, and thus is designed such that video light is directed toward an optimal viewing range of the system by enlarging the light diffusion property of the light source illustrated in FIG. 28 or making the light source have a directionality when the panel size is 7 inches or less, for example.

Furthermore, to obtain horizontal and vertical directionalities and a diffusion property depending on a required specification of the system, a shape, a surface roughness, a slope, and the like of the reflection surface of the light guiding body in the above-described light source apparatus 13 need to be optimally designed.

### <Example 1 of Light Source Apparatus>

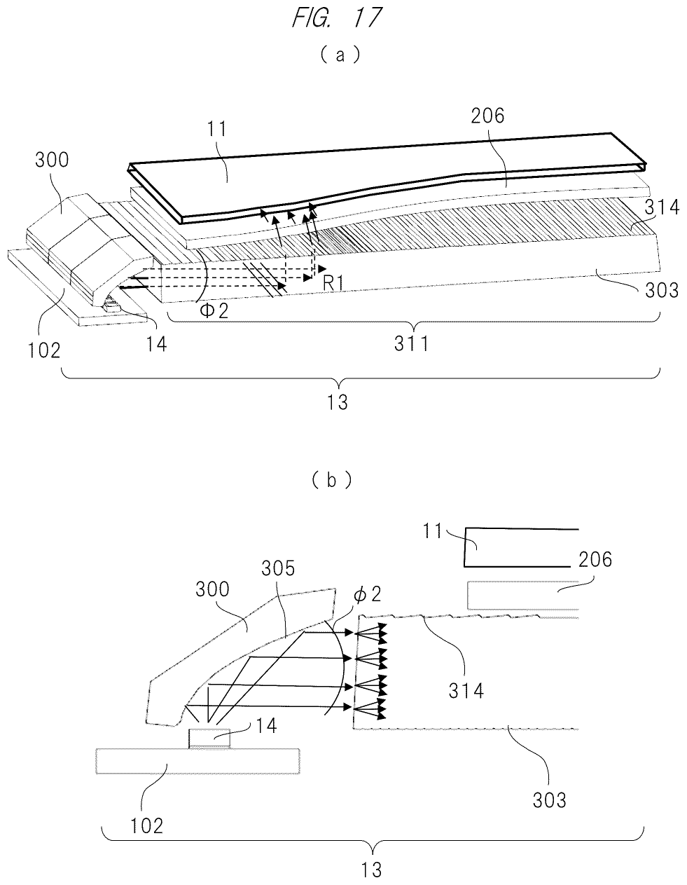

Then, another example of a light source apparatus will be described with reference to FIG. 17. FIGS. 17 (a) and 17 (b) are diagrams with a liquid crystal display panel 11 and a diffusion plate 206 partially omitted to describe a light guiding body 311.

FIG. 17 illustrates a state where a substrate 102 is provided with LEDs 14 constituting a light source. Each of the LEDs 14 and the substrate 102 are respectively attached to predetermined positions relative to a reflector 15.

As illustrated in FIG. 17 (a), the LEDs 14 are aligned in a direction parallel to a side (a short side in this example) of the liquid crystal display panel 11 on the side on which a reflector 300 is arranged. In the illustrated example, the reflector 300 is arranged to correspond to an arrangement of the LEDs. Note that a plurality of reflectors 300 may be arranged.

In one specific example, each of the reflectors 300 is formed of a plastic material. Although the reflector 300 may be formed of a metal material or a glass material as another example, the plastic material is more easily molded. Accordingly, the reflector made of the plastic material is used in this example. As illustrated in FIG. 17 (b), a surface on the inner side (the right side in the drawing) of the reflector 300 includes a reflection surface (which may be hereinafter referred to as a “paraboloidal surface”) 305 having a shape obtained by cutting a paraboloidal surface on a meridian. The reflector 300 reflects divergent light to be emitted from the LED 14 by the above-described reflection surface 305 (the paraboloidal surface), to convert the divergent light into substantially collimated light and make the converted light incident on an end surface of the light guiding body 311. As a specific example, the light guiding body 311 is a transmission-type light guiding body.

The reflection surface of the reflector 300 has a shape asymmetric with respect to an optical axis of light emitted from the LED 14. Further, the reflection surface 305 of the reflector 300 is the paraboloidal surface, as described above. The LED is arranged on a focal point of the paraboloidal surface, to convert a luminous flux after reflection into substantially collimated light.

The LED 14 cannot convert the divergent light from the LED into completely collimated light even if arranged on the focal point of the paraboloidal surface because it is a surface light source, but does not influence the performance of the light source in the invention of the present application. The LED 14 and the reflector 300 are paired. In order to ensure a predetermined performance in an attachment accuracy±40 μm of the LED 14 to the substrate 102, the number of LEDs to be attached to the substrate should be a maximum of ten, and may be suppressed to about five in consideration of mass productivity.

Although the LED 14 and the reflector 300 are made partially close to each other, heat can be radiated into a space on the side of an opening of the reflector 300. Therefore, an increase in temperature of the LED can be reduced. Accordingly, the reflector 300 as a plastic molded product can be used. As a result, the shape accuracy of the reflection surface can be improved by ten times or more that of a reflector made of a glass material, thereby making it possible to improve a light utilization efficiency.

On the other hand, a reflection surface is provided on a bottom surface 303 of the light guiding body 311, and light from the LED 14 is converted into a collimated luminous flux by the reflector 300, is then reflected by the reflection surface, and is emitted toward the liquid crystal display panel 11 arranged to oppose the light guiding body 311. The reflection surface provided on the bottom surface 303 may have a plurality of surfaces respectively having different slopes in a traveling direction of the collimated luminous flux from the reflector 300, as illustrated in FIG. 17. Each of the plurality of surfaces respectively having different slopes may have a shape extending in a direction perpendicular to the traveling direction of the collimated luminous flux from the reflector 300.

Further, a shape of the reflection surface provided on the bottom surface 303 may be a planar shape. At this time, light reflected by the reflection surface provided on the bottom surface 303 of the light guiding body 311 is refracted by a refraction surface 314 provided on a surface, which opposes the liquid crystal display panel 11, of the light guiding body 311, thereby adjusting a light amount and an emission direction of the luminous flux propagating toward the liquid crystal display panel 11 with a high accuracy.

The refraction surface 314 may have a plurality of surfaces respectively having different slopes in the traveling direction of the collimated luminous flux from the reflector 300, as illustrated in FIG. 17. Each of the plurality of surfaces respectively having different slopes may have a shape extending in the direction perpendicular to the traveling direction of the collimated luminous flux from the reflector 300. Light reflected by the reflection surface provided on the bottom surface 303 of the light guiding body 311 is refracted toward the liquid crystal display panel 11 by the respective slops of the plurality of surfaces. Further, the refraction surface 314 may be a transmission surface.

Note that when the diffusion plate 206 is located in front of the liquid crystal display panel 11, the light reflected by the reflection surface is refracted toward the diffusion plate 206 by the plurality of slops of the refraction surface 314. That is, an extension direction of the plurality of surfaces respectively having different slopes of the refraction surface 314 and an extension direction of the plurality of surfaces respectively having different slopes of the reflection surface provided on the bottom surface 303 are parallel to each other. When both the extension directions are made parallel to each other, an angle of light can be more preferably adjusted. On the other hand, the LED 14 is soldered to the metallic substrate 102. Accordingly, heat generated by the LED can be radiated into air through the substrate.

Further, although the reflector 300 may contact the substrate 102, a space may be provided therebetween. When the space is provided, the reflector 300 is arranged to adhere to a housing. When the space is provided, heat generated by the LED can be radiated into air, resulting in an increased cooling effect. As a result, an operation temperature of the LED can be reduced, thereby implementing a maintenance of a luminous efficiency and an increase in lifetime.

### <Another Example 2 of Light Source Apparatus>

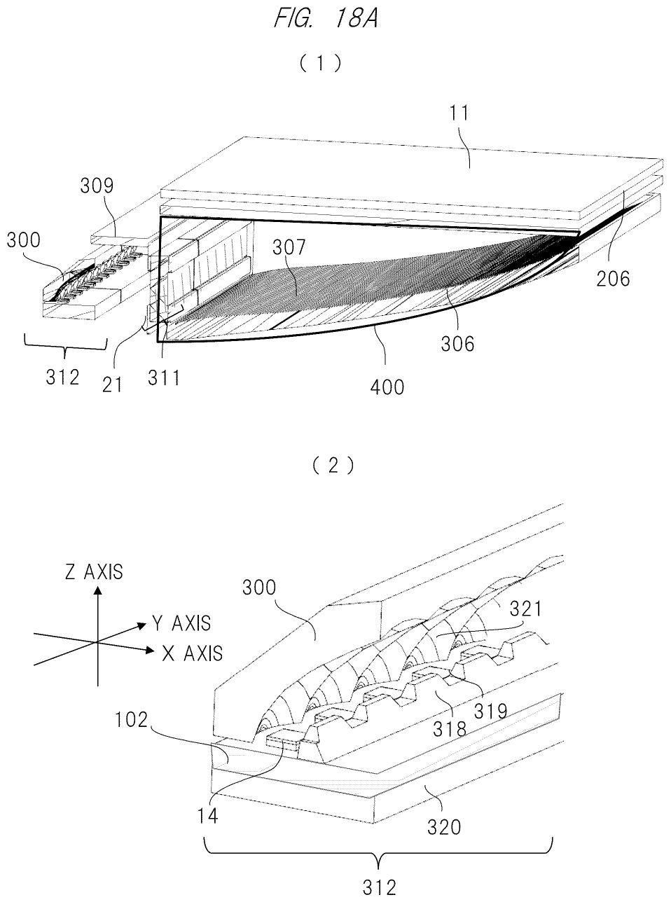

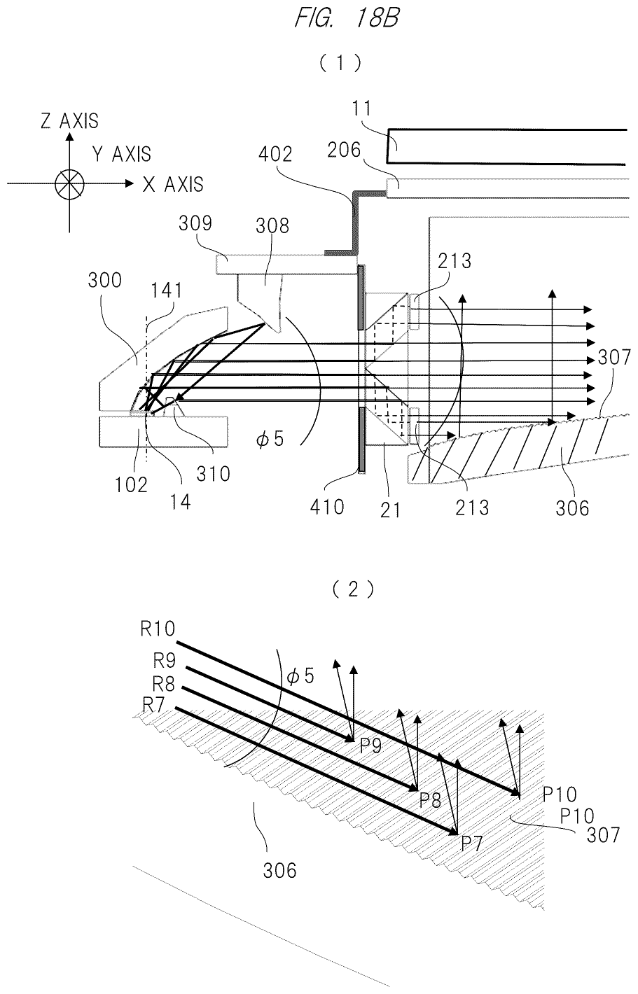

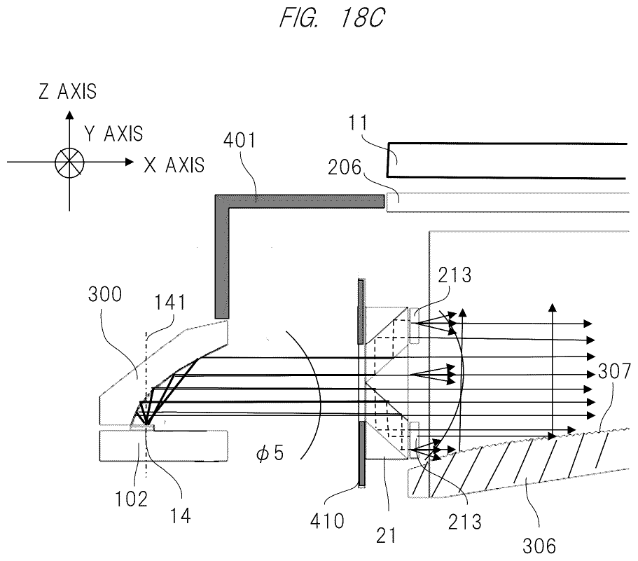

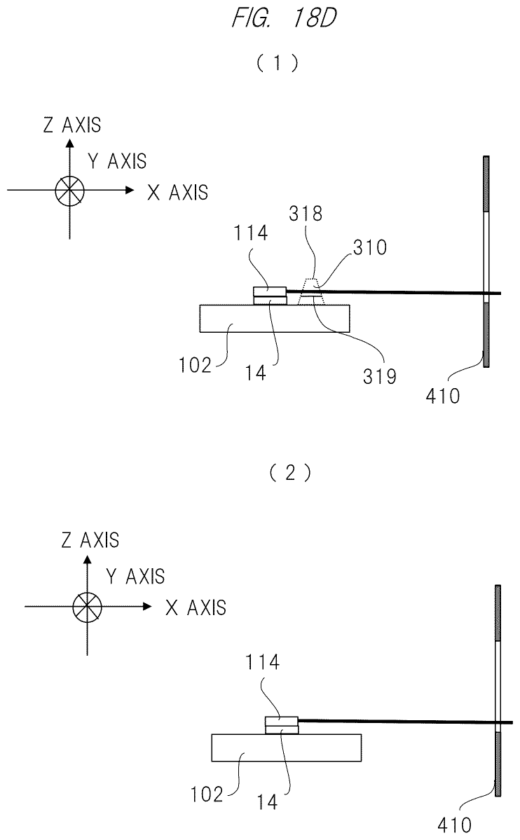

Then, a configuration of an optical system related to a light source apparatus having a light utilization efficiency that is improved by 1.8 times that of the light source apparatus illustrated in FIG. 17 using light polarization conversion will be described in detail with reference to FIGS. 18A, 18B, 18C, and 18D. Note that illustration of a sub reflector 308 is omitted in FIG. 18A.

FIGS. 18A, 18B, and 18C each illustrate a state where a substrate 102 is provided with LEDs 14 constituting a light source. The reflector 300 and each of the LEDs 14 are set as a pair of blocks, to constitute a unit 312 including a plurality of blocks.

Among them, a base material 320 illustrated in FIG. 18A (2) is a base material of the substrate 102. Generally, the metallic substrate 102 has heat. Accordingly, in order to (thermally) insulate heat of the substrate 102, a plastic material or the like may be used for the base material 320. A material for and a shape of a reflection surface of the reflector 300 may be the same material and shape as those in the example of the light source apparatus illustrated in FIG. 26.

Further, the reflection surface of the reflector 300 may have a shape asymmetric with respect to an optical axis of light emitted from the LED 14. The reason for this will be described with reference to FIG. 18A (2). In this example, the reflection surface of the reflector 300 is a paraboloidal surface, like in the example illustrated in FIG. 17, and the center of a light emission surface of the LED as a surface light source is arranged at a focal position of the paraboloidal surface.

Further, in terms of a property of the paraboloidal surface, lights respectively emitted from four corners of the light emission surface are also converted into a substantially collimated luminous flux, and only differ in emission directions. Accordingly, even if a light emission part has an area, an amount and a conversion efficiency of light to be incident on a polarization conversion element 21 arranged in a succeeding stage are hardly affected if a distance between the polarization conversion element and the reflector 300 is small.

Further, even if an attachment position of each of the LEDs 14 shifts within an XY plane with respect to a focal point of the corresponding reflector 300, an optical system capable of reducing a reduction in the light conversion efficiency due to the above-described reason can be implemented. Furthermore, even if the attachment position of the LED 14 varies in a Z-axis direction, the collimated luminous flux obtained by the conversion only moves within a ZX plane, so that an attachment accuracy of the LED as the surface light source can be significantly reduced. Although the reflector 300 having a reflection surface obtained by cutting a part of the paraboloidal surface on a meridian has also been described in this example, the LED may be arranged in a cut portion as a reflection surface of the entire paraboloidal surface.

On the other hand, this example has a characteristic configuration in which divergent light from the LED 14 is reflected by a paraboloidal surface 321 and converted into substantially collimated light, is then incident on an end surface of the polarization conversion element 21 in the succeeding stage, and is equalized to have a specific polarized wave by the polarization conversion element 21, as illustrated in FIGS. 18B (1) and 18C. According to this characteristic configuration, in the present invention, the light utilization efficiency is 1.8 times that in the example illustrated in FIG. 26, thereby making it possible to implement a highly efficient light source.

Note that all substantially collimated lights obtained by reflecting the divergent light from the LED 14 having the paraboloidal surface 321 are not all equal at this time. Therefore, an angular distribution of the reflected light is adjusted by a reflection surface 307 having a plurality of slops so that the reflected light can be incident on the liquid crystal display panel 11 in a vertical direction toward the liquid crystal display panel 11.

Here, in the example illustrated in the drawing, an arrangement is made such that a direction of light (a principal ray) entering the reflector from the LED and a direction of light entering the liquid crystal display panel are substantially parallel to each other. This arrangement is easily made in terms of design, and an arrangement of a heat source below the light source apparatus is more preferable because air is released upward so that an increase in temperature of the LED can be reduced.

Further, as illustrated in FIG. 18B (1), in order to improve a capture rate of the divergent light from the LED 14, a luminous flux that cannot be captured by the reflector 300 is reflected by a sub reflector 308 provided on a light shielding plate 309 arranged above the reflector, is reflected by an inclined surface of the sub reflector 310 below the reflector, and is incident on an effective region of the polarization conversion element 21 in the succeeding stage, thereby further improving the light utilization efficiency. That is, in this example, a part of the light reflected by the reflector 300 is reflected by the sub reflector 308, and the light reflected by the sub reflector 308 is reflected in a direction toward a light guiding body 306 by the sub reflector 310.

The substantially collimated luminous flux equalized to have a specific polarized wave by the polarization conversion element 21 is reflected toward the liquid crystal display panel 11 arranged to oppose the light guiding body 306 by a reflection shape provided on a front surface of the reflection-type light guiding body 306. At this time, a light amount distribution of the luminous flux to be incident on the liquid crystal display panel 11 is optimally designed depending on a shape and an arrangement of the reflector 300, described above, and a shape (cross-sectional shape), a slope, and a surface roughness of a reflection surface of the reflection-type light guiding body.

A plurality of reflection surfaces are arranged to oppose the emission surface of the polarization conversion element as the reflection surface shape provided on the front surface of the light guiding body 306, and a slope, an area, a height, and a pitch of the reflection surfaces are optimized depending on a distance from the polarization conversion element 21, thereby setting the light amount distribution of the luminous flux to be incident on the liquid crystal display panel 11 to a desired value, as described above.

When the reflection surface 307 provided on the reflection-type light guiding body is configured to have a plurality of slops on its one surface, as illustrated in FIG. 18B (2), reflected light can be adjusted with a higher accuracy. Note that as a configuration in which the reflection surface has a plurality of slops on its one surface, a region to be used as the reflection surface may be a plurality of surfaces, a polygonal surface, or a curved surface. Furthermore, a more uniform light amount distribution is implemented by a diffusion function of a diffusion plate 206. A uniform light amount distribution of light to be incident on the diffusion plate on the side closer to the LED can be implemented by changing the slopes of the reflection surface.

In this example, a plastic material such as heat-resistant polycarbonate is used as a base material for the reflection surface 307. Further, an angle of the reflection surface 307 immediately after emission from a λ/2 plate 213 changes depending on a distance between the λ/2 plate and the reflection surface.

In this example, the LED 14 and the reflector 300 are also partially close to each other. However, heat can be radiated into a space on the side of the opening of the reflector 300, so that an increase in temperature of the LED can be reduced. Further, the substrate 102 and the reflector 300 may be arranged upside down relative to those illustrated in FIGS. 18A, 18B, and 18C.

However, if the substrate 102 is arranged on the upper side, the substrate 102 is close to the liquid crystal display panel 11. Accordingly, a layout may be difficult. Therefore, an arrangement of the substrate 102 below the reflector 300 (the side farther from the liquid crystal display panel 11), as illustrated in the drawing, makes a configuration inside the apparatus simpler.

A light incidence surface of the polarization conversion element 21 may be provided with a light shielding plate 410 such that unnecessary light is not incident on an optical system in the succeeding stage. Such a configuration makes it possible to implement a light source apparatus in which an increase in temperature is suppressed. Although a light polarization plate provided on a light incidence surface of the liquid crystal display panel 11 absorbs a luminous flux having equalized light polarization in the invention of the present application to reduce the increase in temperature, a part of light is absorbed by the incidence-side light polarization plate because its light polarization direction is rotated when reflected by the reflection-type light guiding body. Furthermore, the temperature of the liquid crystal display panel 11 also increases by an increase in temperature due to absorption in liquid crystals themselves and light incident on an electrode pattern. However, there is a sufficient space between the reflection surface of the reflection-type light guiding body 306 and the liquid crystal display panel 11, thereby enabling natural cooling.

FIG. 18D illustrates a modification example of the light source apparatus illustrated in FIGS. 18B (1) and 18C. FIG. 18D (1) illustrates a modification example of the light source apparatus illustrated in FIG. 18B (1) with its part extracted. Other components are the same as those in the above-described light source apparatus illustrated in FIG. 18B (1), and hence illustration and repetitive description thereof will be omitted.

First, in the example illustrated in FIG. 18D (1), the height of a concave portion 319 in a sub reflector 310 is adjusted to be lower than that of a position of a fluorescent body 114 such that a principal ray of a fluorescence (see a straight line extending in a direction parallel to an X axis in FIG. 18D (1)) to be outputted in a transverse direction (X-axis direction) from the fluorescent body 114 is released out of the concave portion 319 in the sub reflector 310. Furthermore, the height of a light shielding plate 410 is adjusted to be lower in a Z-axis direction than that of a position of the fluorescent body 114 such that the principal ray of the fluorescence to be outputted in the transverse direction from the fluorescent body 114 is incident on an effective region of a polarization conversion element 21 without being blocked by the light shielding plate 410.

Further, a reflection surface of a convex portion in convex and concave on an apex portion of the sub reflector 310 reflects light reflected by the sub reflector 308 to guide the light reflected by the sub reflector 308 into a light guiding body 306. Accordingly, the height of the convex portion 318 in the sub reflector 310 is adjusted such that the light reflected by the sub reflector 308 is reflected and is incident on the effective region of the polarization conversion element 21 in a succeeding stage, thereby making it possible to further improve a light utilization efficiency.

Note that the sub reflector 310 is arranged to extend in one direction, as illustrated in FIG. 18A (2), and has a convex and concave shape. Furthermore, on the apex portion of the sub reflector 310, convex and concave including one or more convex portions are periodically arranged in one direction. Such a convex and concave shape enables a configuration in which the principal ray of the fluorescence to be outputted in the transverse direction from the fluorescent body 114 is incident on the effective region of the polarization conversion element 21.

Further, the convex and concave shape of the sub reflector 310 is periodically arranged at a pitch at which the concave portion 319 is located at a position of an LED 14. That is, each florescent body 114 is periodically arranged in one direction to correspond to an arrangement pitch of the concave portions in the convex and concave of the sub reflector 310. Note that when the LED 14 includes the fluorescent body 114, the florescent body 114 may be expressed as a light emission portion of a light source.

Further, FIG. 18D (2) illustrates a modification example of the light source apparatus illustrated in FIG. 18C with its part extracted. Other components are the same as those in the light source apparatus illustrated in FIG. 18C, and hence illustration and repetitive description thereof will be omitted. As illustrated in FIG. 18D (2), the sub reflector 310 may be eliminated. However, the height of the light shielding plate 410 is adjusted to be lower in the Z-axis direction than that of a position of the florescent body 114 such that the principal ray of the fluorescence to be outputted in the transverse direction from the fluorescent body 114 is incident on the effective region of the polarization conversion element 21 without being blocked by the light shielding plate 410, like in FIG. 18D (1).

Note that for the light source apparatus illustrated in FIGS. 18A, 18B, 18C, and 18D, a sidewall 400 may be provided to prevent dust from entering a space between the reflection surface of the reflection-type light guiding body 306 and the liquid crystal display panel 11, prevent generation of stray light toward the outside of the light source apparatus, and prevent entrance of stray light from entering from the outside of the light source apparatus, as illustrated in FIG. 18A (1). The sidewall 400 is arranged to sandwich a space between the light guiding body 306 and the diffusion plate 206 when provided.

The light emission surface of the polarization conversion element 21 that emits light polarization-converted by the polarization conversion element 21 faces a space surrounded by the sidewall 400, the light guiding body 306, the diffusion plate 206, and the polarization conversion element 21. Further, a reflection surface having a reflection film or the like is used as a surface, among inner surfaces of the sidewall 400, of a portion that covers a space into which light is outputted from the emission surface of the polarization conversion element 21 (a space on the right side of the emission surface of the polarization conversion element 21 illustrated in FIG. 18B (1)) from its side surface. That is, a surface of the sidewall 400 facing the above-described space includes a reflection region having a reflection film. When the surface, among the inner surfaces of the sidewall 400, of the portion is used as a reflection surface, light reflected by the reflection surface can be reduced as light source light, thereby making it possible to improve the luminance of the light source apparatus.

The surface, among the inner surfaces of the sidewall 400, of the portion that covers the polarization conversion element 21 from its side surface is set as a surface having a low light reflectance (a black surface having no reflection film, etc.). This is because light in an unexpected light polarization state occurs when reflected light occurs on the side surface of the polarization conversion element 21, causing stray light. In other words, when the above-described surface is set as the surface having a low light reflectance, generation of stray light of a video and light in an unexpected polarization state can be prevented or suppressed. Alternatively, the sidewall 400 may be configured to have a hole through which air passes in its part to improve a cooling effect.

Note that each of the light source apparatus illustrated in FIGS. 18A, 18B, 18C, and 18D has been described on the premise of a configuration using the polarization conversion element 21. However, the light source apparatus may be configured by eliminating the polarization conversion element 21 therefrom. In this case, a light source apparatus can be provided at a lower cost.

### <Another Example 3 of Light Source Apparatus>

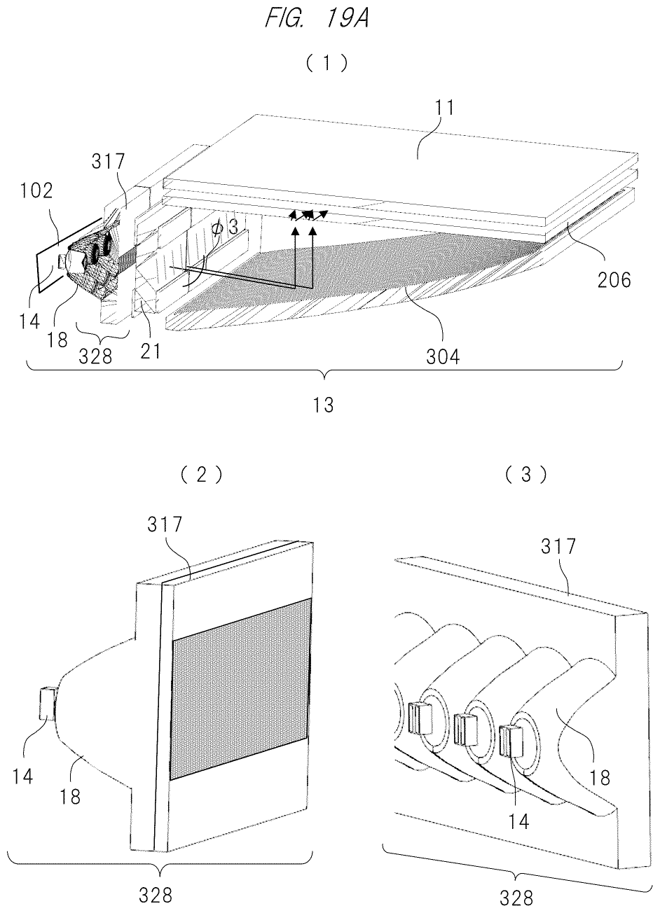

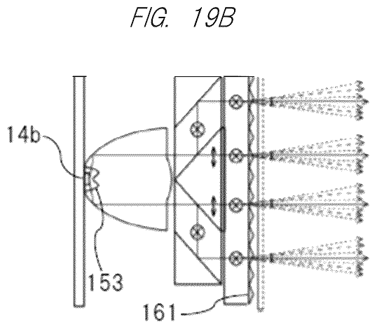

Then, a configuration of an optical system related to a light source apparatus using a reflection-type light guiding body 304 will be described in detail on the basis of the light source apparatus illustrated in the example 1 of the light source apparatus with reference to FIGS. 19A (1), 19A (2), 19A (3), and 19B.

FIG. 19A illustrate a state where a substrate 102 is provided with LEDs 14 constituting a light source. A collimator 18 and each of the LEDs 14 are set as a pair of blocks, to configure a unit 328 including a plurality of blocks. Since the collimator 18 in this example is close to the LED 14, a glass material is used in consideration of a heat resistance. A shape of the collimator 18 is similar to the shape described in the collimator 15 illustrated in FIG. 18. Further, a light shielding plate 317 is provided in a preceding stage where light is incident on a polarization conversion element 21, to prevent or suppress incidence of unnecessary light on an optical system in a succeeding stage, thereby reducing an increase in temperature due to the unnecessary light.

Another configuration and effect of the light source illustrated in FIG. 19A are similar to those illustrated in FIGS. 18A, 18B, 18C, and 18D, and hence repetitive description thereof will be omitted. The light source apparatus illustrated in FIG. 19A may be provided with a sidewall, like those described in FIGS. 18A, 18B, and 18C. A configuration and an effect of the sidewall have already described, and hence repetitive description thereof will be omitted.

FIG. 19B is a cross-sectional view of FIG. 19A (2). A configuration of a light source illustrated in FIG. 19B is common to a part of the structure of the light source illustrated in FIG. 18, and has already been described in FIG. 18, and hence repetitive description thereof will be omitted.

### <Another Example 4 of Light Source Apparatus>

Then, in a light source apparatus illustrated in FIG. 23, the collimator 18 and the LED 14 used in the light source apparatus illustrated in FIG. 19 are set as a pair of blocks, to configure the unit 328 including a plurality of blocks. A configuration of an optical system related to a light source apparatus using an LED and a reflection-type light guiding body 504 respectively arranged at both ends of a back surface of a liquid crystal display panel 11 will be described in detail with reference to FIGS. 23 (a), 23 (b), and 23 (c).

FIG. 23 illustrate a state where a substrate 505 is provided with LEDs 14 constituting a light source. A collimator 18 and each of the LEDs 14 are set as a pair of blocks, to configure a unit 503 including a plurality of blocks. Units 503 are respectively arranged at both the ends of the back surface of the liquid crystal display panel 11 (three units are arranged side by side in a short-side direction in this example). Light outputted from each of the units 503 is reflected by the reflection-type light guiding body 504, and is incident on the liquid crystal display panel 11 (illustrated in FIG. 23 (c)) arranged to oppose the reflection-type light guiding body 504.

The reflection-type light guiding body 504 is separated into two blocks respectively corresponding to units arranged at its ends and is arranged such that its central portion is the highest, as illustrated in FIG. 23 (c). Since the collimator 18 is close to the LED 14, a glass material is used in consideration of a heat resistance against heat to be generated from the LED 14. A shape of the collimator 18 is the shape described in the collimator 15 illustrated in FIG. 18.

Light from the LED 14 is incident on a polarization conversion element 501 through the collimator 18. A distribution of light to be incident on the reflection-type light guiding body 504 in a succeeding stage is adjusted depending on a shape of an optical element 81. That is, a light amount distribution of a luminous flux to be incident on the liquid crystal display panel 11 is optimally designed by adjusting the above-described shape and an arrangement of the collimator 18, the shape and a diffusion property of the optical element 81, and a shape (cross-sectional shape) of a reflection surface of the reflection-type light guiding body, a slope of the reflection surface, a surface roughness of the reflection surface.

As the shape of the reflection surface provided on a front surface of the reflection-type light guiding body 504, a plurality of reflection surfaces are arranged to oppose an emission surface of the polarization conversion element, as illustrated in FIG. 23 (b). A slope, an area, a height, and a pitch of the reflection surfaces are optimized depending on a distance from the polarization conversion element 21. Further, a region to be the same reflection surface (i.e., a surface opposing the polarization conversion element) is separated into polyhedrons, so that a light amount distribution of a luminous flux to be incident on the liquid crystal display panel 11 can be set to a desired value (optimized), as described above.

One surface (a light reflection region) of the reflection surface provided on the reflection-type light guiding body is configured to have a shape having a plurality of slops (constituted by 14-separated surfaces respectively having different slops within an XY plane in an example illustrated in FIG. 23), like in the reflection-type light guiding body described in FIG. 18B, so that reflected light can be adjusted with a higher accuracy. Further, when a light shielding wall 507 is provided in order to prevent the reflected light from the reflection-type light guiding body from leaking through a side surface of the light source apparatus 13, leak light can be prevented from being generated in a direction other than a desired direction (a direction toward the liquid crystal display panel 11).

Further, the units 503 respectively arranged on the left and right of the reflection-type light guiding body 504 illustrated in FIG. 23 may be each replaced with the light source apparatus illustrated in FIG. 18. That is, a plurality of light source apparatuses (each including a substrate 102, a reflector 300, an LED 14, and the like) illustrated in FIG. 18 may be prepared, and the plurality of light source apparatuses may be respectively arranged at positions opposing one another, as referred to by FIGS. 23 (a), 23 (b), and 23 (c).

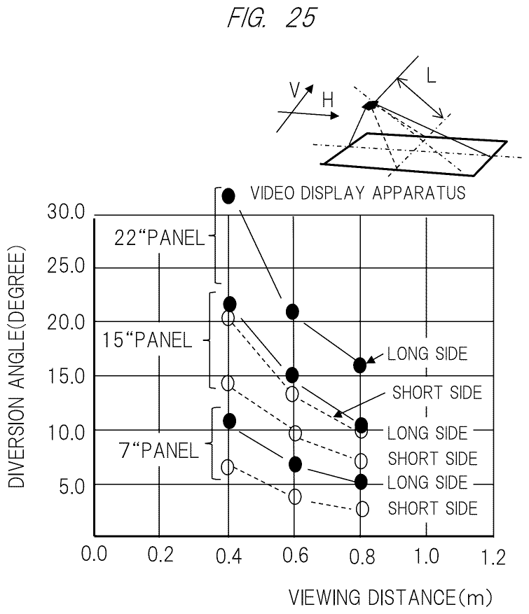

FIG. 24(B) illustrates a light source apparatus configured by arranging six units 503 and six units 503 illustrated in FIG. 24(A), respectively, on the upper and lower sides. As illustrated in the drawing, a current is controlled by a single power supply as a unit configuration in which five LEDs are arranged side by side to obtain a desired luminance. Accordingly, as a light source apparatus that illuminates a liquid crystal panel, each of the units can control a light source luminance for each region to be irradiated. In a configuration illustrated in FIG. 24, there are a reflection surface 502 different from a reflection surface 222 and the reflection surface 222. The reflection surface 222 has a shape like horizontal grids or a strip shape having a predetermined width. The reflection surface 502 has a shape like vertical and horizontal grids. A luminance and an angle of reflected light can be finely controlled by these shapes. Accordingly, even if a single light source is used for the planar display and the air floating video information apparatus illustrated in each of FIGS. 14 and 15, a light source luminance can be controlled for each irradiation region.

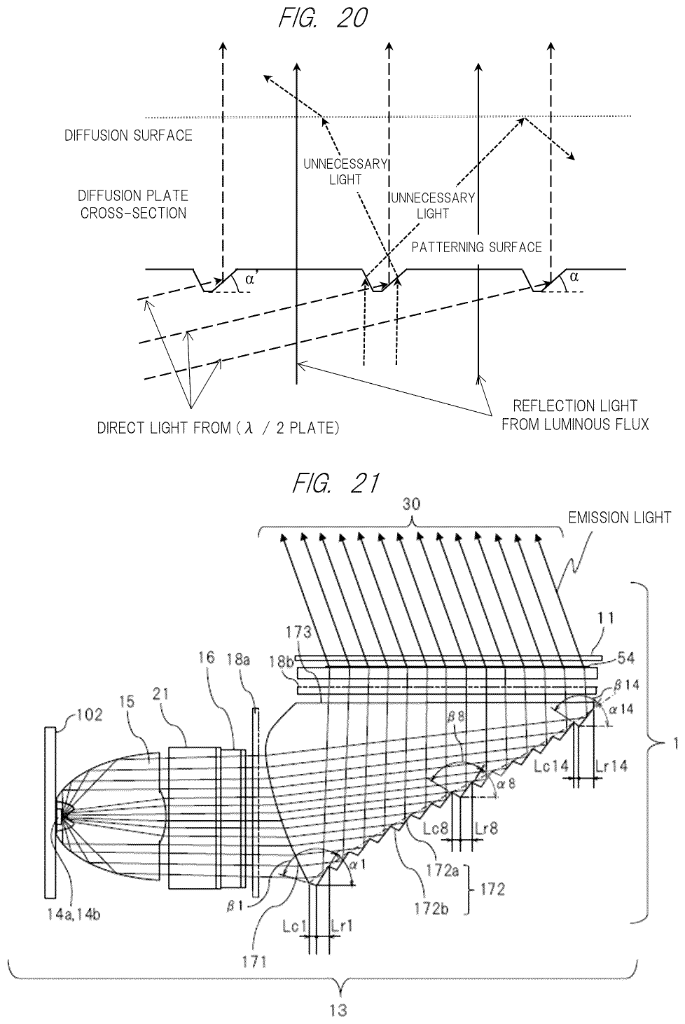

FIG. 20 is a cross-sectional view illustrating an example of a shape of the diffusion plate 206. As described above, divergent light outputted from the LED is converted into substantially collimated light by the reflector 300 or the collimator 18, is converted to have a specific polarized wave by the polarization conversion element 21, and is then reflected by the light guiding body. Then, a luminous flux reflected by the light guiding body is incident on the liquid crystal display panel 11 after passing through a planar portion of an incidence surface of the diffusion plate 206 (see two solid-line arrows indicating “reflected light from the light guiding body” in FIG. 19″).

A divergent luminous flux in light emitted from the polarization conversion element 21 is totally reflected by an inclined surface of a protrusion having a slope provided on the incidence surface of the diffusion plate 206, and is incident on the liquid crystal display panel 11. In order to totally reflect the light emitted from the polarization conversion element 21 by the inclined surface of the protrusion of the diffusion plate 206, an angle of the inclined surface of the protrusion is changed on the basis of a distance from the polarization conversion element 21. Letting a be an angle of the inclined surface of the protrusion on the side far from the polarization conversion element 21 or the side far from the LED and letting a′ be an angle of the inclined surface of the protrusion on the side close to the polarization conversion element 21 or the side close to the LED, α is smaller than α′ (α<α′). Such setting makes it possible to effectively use the luminous flux polarization-converted.

### <Diffusion Property Control Technique for Video Display Apparatus>

Examples of a method for adjusting a diffusion distribution of video light from the liquid crystal display panel 11 include a method for providing a lenticular lens between the light source apparatus 13 and the liquid crystal display panel 11 or on the front surface of the liquid crystal display panel 11 to optimize a shape of the lens. That is, when the shape of the lenticular lens is optimized, an emission property of video light (hereinafter also referred to as a “video luminous flux”) to be emitted in one direction from the liquid crystal display panel 11 can be adjusted.

Alternatively or additionally, a microlens array may be arranged in a matrix shape on the front surface of the liquid crystal display panel 11 (or between the light source apparatus 13 and the liquid crystal display panel 11) to adjust a mode of the arrangement. That is, when the arrangement of the microlens array is adjusted, an emission property in an X-axis direction and a Y-axis direction of the video luminous flux to be emitted from the video display apparatus 1 can be adjusted. As a result, a video display apparatus having a desired diffusion property can be obtained.

As a further configuration example, a combination of two lenticular lenses may be arranged or a sheet in which a microlens array is arranged in a matrix shape to adjust a diffusion property may be provided at a position through which video light to be emitted from the video display apparatus 1 passes. Such an optical system configuration makes it possible to adjust a luminance (relative luminance) of video light in an X-axis direction and a Y-axis direction depending on a reflection angle of the video light (a reflection angle when using reflection in a vertical direction as a reference (0 degrees)).

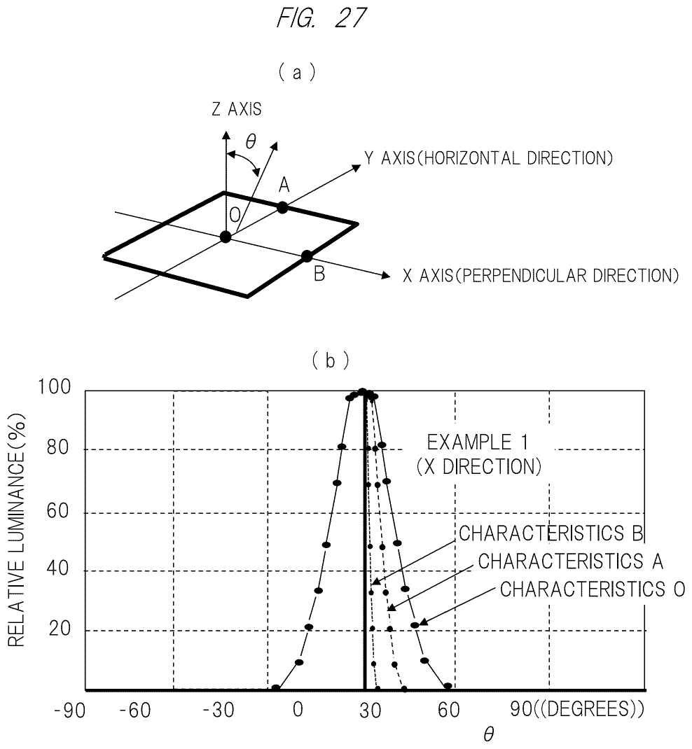

In this example, such a lenticular lens is used, so that an excellent optical property can be acquired, as illustrated in a graph (plot curves) of an “example 1 (Y-direction)” and an “example 2 (Y-direction)” in FIG. 27 (b), which clearly differs from a graph (plot curves) of a conventional property. Specifically, in the respective plot curves of the example 1 (Y-direction) and the example 2 (Y-direction), a luminance property in a vertical direction is made sharp, and a balance of a directionality in an up-down direction (a positive-negative direction of a Y axis) is further changed, thereby making it possible to increase a luminance (relative luminance) of light due to reflection and diffusion.

Accordingly, this example makes it possible to provide video light having a narrow diffusion angle (high straightness) and having only a specific polarized wave component, like video light from a surface light emission laser video source, and adjust the video light to suppress a ghost image, which has been generated in a retroreflector when the video display apparatus according to the related art is used, and make an air floating image generated by retroreflection efficiently reach the eyes of a viewing person.

Further, the above-described light source apparatus makes it possible to make a diffusion property (denoted by a “related-art property” in the drawings) of light emitted from a general liquid crystal display panel illustrated in FIGS. 28(A) and 28(B) have a directionality having a significantly narrow angle in both an X-axis direction and a Y-axis direction. In this example, a video display apparatus that emits a substantially collimated video luminous flux in a specific direction and emits light with a specific polarized wave can be implemented by providing such a directionality having a narrow angle.

FIG. 27 illustrates an example of a property of a lenticular lens to be used in this example. In this example, a property in an X-direction (vertical direction) with a Z axis as a reference is particularly illustrated, and a property O indicates a luminance property having a peak in a light emission direction at an angle close to 30 degrees upward from a vertical direction (0 degrees) and being symmetric in an up-down direction. Further, plot curves of a property A and a property B illustrated in a graph of FIG. 27 further respectively indicate property examples in which a luminance (relative luminance) is increased by collecting upper video light having a peak luminance at an angle close to 30 degrees. Accordingly, in the properties A and B, the luminance (relative luminance) of light rapidly decreases in a region at an angle where a slope (an angle θ) in the X-direction from the Z axis exceeds 30 degrees (θ>30°), as can be seen from comparison with a plot curve of the property O.

That is, according to an optical system including the above-described lenticular lens, when a video luminous flux from the video display apparatus 1 is incident on a retroreflector, an emission angle and a viewing angle of video light having an equalized narrow angle by the light source apparatus 13 can be adjusted, and a degree of freedom of installation ofa retroreflective sheet can be significantly improved. As a result, a degree of freedom related to an image forming position of an air floating image that is formed at a desired position after being reflected or transmitted by a window glass can be significantly improved. As a result, the video light can be made to efficiently reach the eyes of a viewing person outside or inside a room as light having a narrow diffusion angle (high straightness) and having only a specific polarized wave component. This makes it possible for the viewing person to accurately recognize video light from the video display apparatus 1 to obtain information even if the intensity (luminance) of the video light is reduced. In other words, an output of the video display apparatus 1 is reduced, thereby making it possible to implement an information display system with low power consumption.

Various embodiments and examples (specific examples) to which the present invention is applied have been described in detail above. On the other hand, the present invention is not limited to only the above-described embodiment (specific examples), but includes various modification examples. For example, the above-described embodiment has described the entire system in detail to make the present invention easy to understand, and is not necessarily limited to one including all the described components. Further, some of components in an embodiment can be replaced with components in another embodiment, or components in another embodiment can be added to components in an embodiment. Further, for some of components in each embodiment, another component can be added, eliminated, or replaced.

The light source apparatus described above is not limited to the air floating video display apparatus, but is also applicable to an information display apparatus such as an HUD, a tablet, or a digital signage.

In the technique according to the present embodiment, the air floating video is displayed with high-resolution and high-luminance video information floating in air, thereby making it possible for a user to perform an operation without having concern about contact infection in infectious illness, for example. Use of the technique according to the present embodiment for a system to be used by a large number of unspecified users makes it possible to provide a non-contact user interface that the user can use without having concern by reducing a risk of contact infection in infectious illness. The present invention for providing such a technique contributes to “Goal 3: Good Health and Well-being” in sustainable development goals (SDGs) advocated by the United Nations.

Further, in the above-described technique according to the embodiment, only regularly reflected d light is efficiently reflected with respect to a retroreflector by making a divergence angle of video light to be emitted small and equalizing the video light to have a specific polarized wave, resulting in a high light utilization efficiency, thereby making it possible to obtain a bright and clear air floating video. The technique according to the present embodiment makes it possible to provide a non-contact user interface capable of significantly reducing power consumption and being excellent in availability. The present invention for providing such a technique contributes to “Goal 9: Industry, Innovation and Infrastructure” and “Goal 11: Sustainable Cities and Communities” in sustainable development goals (SDGs) advocated by the United Nations.

Furthermore, the above-described technique according to the present embodiment makes it possible to form an air floating video based on video light having a high directionality (straightness). In the technique according to the present embodiment makes it possible to provide a non-contact user interface having less risk of a person other than a user looking into an air floating video by displaying video light having a high directionality even when displaying a video that requires a high security at an ATM of a bank, a ticketing machine of a station, or the like and a video having a high secret level that is desired to be kept secret from a person who faces the user. The present invention provides the above-described technique, thereby contributing to “Goal 11: Sustainable Cities and Communities” in sustainable development goals (SDGs) advocated by the United Nations.

### EXPLANATION OF REFERENCE NUMERALS

1 . . . . Video display apparatus; 2 . . . . First retroreflector; 5 . . . . Second retroreflector; 3 . . . . Space image (air floating image); 100 . . . Transparent sheet; 13 . . . . Light source apparatus; 54 . . . . Light direction conversion panel; 105 . . . . Linear fresnel sheet; 101 . . . Absorption-type light polarization sheet (absorption-type polarization plate); 200 . . . . Planar display; 201 . . . . Hosing; 203 . . . Sensing system; 226 . . . . Sensing area; 102 . . . . Substrate; 11, 335 . . . . Liquid crystal panel; 206 . . . . Diffusing plate; 21 . . . . Polarization conversion element; 300 . . . . Reflector; 213 . . . λ/2 phase plate; 306 . . . . λ/2 phase plate; 306 . . . . Reflection-type light guiding body; 307 . . . . Reflection surfaces; 308, 310 . . . . Sub reflector; 204 . . . . Air floating video; 334 . . . . Video light control sheet; 336 . . . . Light transmission part; 337 . . . . Light absorption part; 81 . . . . Optical element; 501 . . . . Polarization conversion element; 503 . . . . Unit; 507 . . . . Light shielding wall; 401, 402 . . . . Light shielding plate; and 320 . . . . Base material.

1. An air floating video display apparatus comprising:
a first display panel that displays a video;
a light source apparatus for the first display panel;
a retroreflector that reflects video light from the first display panel and displays an air floating video as a real image in air by the reflected light; and
a second display panel that displays the video on its surface.

2. The air floating video display apparatus according to claim 1, further comprising a first sensor that senses a spatial region corresponding to the air floating video.

3. The air floating video display apparatus according to claim 2, further comprising a second sensor that performs sensing corresponding to the video displayed by the second display panel.

4. The air floating video display apparatus according to claim 3, wherein
a sensing region of the first sensor and a sensing region of the second sensor exist in the same plane.

5. The air floating video display apparatus according to claim 2, wherein
the first sensor is a TOF (time of flight)-type sensor including a light source and a light receiving part.

6. The air floating video display apparatus according to claim 3, wherein
the second sensor is a TOF (time of flight)-type sensor including a light source and a light receiving part.

7. The air floating video display apparatus according to claim 5, wherein
a wavelength of light source light of the first sensor is a wavelength of 900 (nm) or more.

8. The air floating video display apparatus according to claim 6, wherein
a wavelength of light source light of the second sensor is a wavelength of 900 (nm) or more.

9. The air floating video display apparatus according to claim 1, wherein
the light source apparatus comprises
a point-like or planar light source, and
a reflector that reflects light from the light source, and
a light guiding body that guides the light from the reflector toward the first display panel,
wherein a reflection surface of the reflector has a shape asymmetric with respect to an optical axis of light emitted from the light source.

10. The air floating video display apparatus according to claim 9, wherein
the light guiding body is a reflection-type light guiding body.

11. The air floating video display apparatus according to claim 9, further comprising:
a diffusion plate that diffuses light from the light guiding body; and
a sidewall arranged so as to sandwich a space between the light guiding body and the diffusion plate.

12. The air floating video display apparatus according to claim 9, wherein
a plastic material, a glass material, or a metal material is used for the reflector.

13. An air floating video display apparatus comprising:
a display panel that displays a image;
a light source apparatus;
a retroreflector that reflects video light from the display panel and displays an air floating video as a real image in air by the reflected light; and
a first video light control sheet arranged close to a video display surface of the display panel, wherein
a video luminous flux whose light emission direction is controlled by the first image light control sheet displays the air floating video after being reflected by the retroreflector, and
the retroreflector is inclined and arranged so that an angle of incidence at which external light is incident on the retroreflector is 35 degrees or more and that an end surface of the retroreflector on a side of a video monitoring person is lower than another surface.

14. The air floating video display apparatus according to claim 13, further comprising a first sensor that senses a spatial region corresponding to the air floating video, wherein
the first sensor is a TOF (time of flight)-type sensor including a light source and a light receiving part.

15. The air floating video display apparatus according to claim 13, wherein
the air floating video display system is a system in which a video monitoring person looks down and monitors the air floating video,
the display panel and the retroreflector are arranged in this order from a position far from the video monitoring person, and
video light from the display panel is controlled by the first video light control sheet arranged close to a video display surface of the display panel, and light through the first video light control sheet is reflected by the retroreflector, and an air floating video as a real image is displayed in air by the reflected light.

16. An air floating video display apparatus comprising:
a display panel that displays a video;
a light source apparatus for the display panel; and
a retroreflector that reflects video light from the display panel and displays an air floating video as a real image in air by the reflected light,
wherein the retroreflector is inclined and arranged with its lower portion pulled out in a forward direction with respect to an upper portion of the air floating video display system, and is arranged such that the video light is inclined to be incident on the retroreflector.

17. The air floating video display apparatus according to claim 16, wherein
the light source apparatus includes:
a point-like or planar light source;
a reflector that reflects light from the light source; and
a light guiding body that guides the light from the reflector toward the display panel,
wherein a reflection surface of the reflector has a shape asymmetric with respect to an optical axis of light emitted from the light source.

18. The air floating video display apparatus according to claim 17, wherein
the light guiding body is a reflection-type light guiding body.

19. The air floating video display apparatus according to claim 17, further comprising:
a diffusion plate that diffuses light from the light guiding body; and
a sidewall arranged to sandwich a space between the light guiding body and the diffusion plate.

20. The air floating video display apparatus according to claim 17, wherein
a plastic material, a glass material, or a metal material is used for the reflector.

21. An air floating video display apparatus comprising:
a display panel that displays a video;
a light source apparatus that supplies light to the display panel;
a retroreflector that reflects video light from the display panel and displays an air floating video as a real image in air by the reflected light; and
a luminous flux traveling direction change sheet arranged between the display panel and the retroreflector.

22. The air floating video display apparatus according to claim 21, wherein
the luminous flux traveling direction change sheet is arranged on a front surface of the display panel to change a traveling direction of video light from the display panel and make the video light incident on the retroreflector.

23. The air floating video display apparatus according to claim 21, wherein
the luminous flux traveling direction change sheet changes an angle of incidence of video light on the retroreflector from the display panel.

24. The air floating video display apparatus according to claim 21, wherein
the luminous flux traveling direction change sheet is a linear fresnel sheet, and
the linear fresnel sheet has a convex and concave portion on its surface opposing the display panel.

25. An air floating video display apparatus comprising:
a display panel that displays a video;
a light source apparatus that supplies light to the display panel;
a retroreflector that reflects video light from the display panel and displays an air floating video as a real image in air by the reflected light; and
a video light control sheet arranged between the display panel and the air floating video.

26. The air floating video display apparatus according to claim 25, wherein
the video light control sheet is arranged between the display panel and the retroreflector.

27. The air floating video display apparatus according to claim 25, wherein
the video light control sheet is arranged between the retroreflector and the air floating video.

28. The air floating video display apparatus according to claim 25, wherein
the video light control sheet is arranged on a front surface of the display panel.

29. The air floating video display apparatus according to claim 25, wherein
the video light control sheet is arranged on a front surface or a back surface of the retroreflector.

30. The air floating video display apparatus according to claim 26, wherein
the video light control sheet is arranged perpendicularly to light incident on the video light control sheet.

31. The air floating video display apparatus according to claim 21, wherein
the retroreflector is arranged such that an angle formed between a front surface of the display panel and the retroreflector and an angle formed between the retroreflector and the air floating video are equal to each other.

32. The air floating video display apparatus according to claim 21, wherein
the air floating video is formed at a plane-symmetric position of the display panel with the retroreflector used as a plane of symmetry.
